(19) United States
(12) Patent Application Publication
(10) Pub. No.: US 2019/0368579 A1
(43) Pub. Date: Dec. 5, 2019

(54) TRANSMISSION DEVICE FOR GEAR SWITCHING, AND HUMAN-POWERED VEHICLE COMPRISING SAID DEVICE

(71) Applicant: Paolo MENICHETTI, Santa Maria a Colle (LU) (IT)

(72) Inventor: Paolo MENICHETTI, Santa Maria a Colle (LU) (IT)

(21) Appl. No.: 16/462,371

(22) PCT Filed: Nov. 21, 2017
(86) PCT No.: PCT/EP2017/079935

§ 371 Date: May 20, 2019

(30) Foreign Application Priority Data
Nov. 24, 2016 (IT) 102016000118893

(51) Int. Cl. F16H 3/34

(52) U.S. Cl. CPC F16H 3/34; F16H 2200/0013; F16H 2306/46; B62M 6/55; F16H 2704/00; F16H 2200/0065; F16H 2306/50

(57) ABSTRACT

The transmission (10) comprises a support (40) where an input central shaft (1) is rotatably supported. A central wheel (11) is integral with the central shaft (1) and rotates therewith. The transmission further comprises an output wheel (18) and a rotary unit (100) rotatably supported by the support (40) around a rotation axis (100′) to take a plurality of angular positions. Selectable gear pairs (101-109) are rotatably supported on the rotary unit (100). A rotation mechanism of the rotary unit (100) brings the rotary unit (100) into one of said angular position selectively. In each angular position of the rotary unit (100) a selectable gear pair (101-109) transmits motion from the central wheel (11) to the output wheel (18);

### TECHNICAL FIELD

The present invention relates to a gear switching device, herein simply referred to as “transmission”, in particular, although without limitation, for human-powered vehicles.

According to a specific aspect, the invention relates to vehicles like bicycles, bike taxis, tricycles, quadcycles, torpedo bikes, urban rickshaws, tandems and the like.

### BACKGROUND TO THE INVENTION

Devices for gear switching in human-powered vehicles, such as bicycles, are well known; they comprise a plurality of pinions mounted coaxially with the hub of a drive wheel, each pinion having a different diameter so as to define a different gear ratio, a derailleur gear for disengaging the chain from a pinion and making it mesh with another pinion, so as to change gear, and a control, usually a cable manual control, for actuating the derailleur.

In these devices, the pinions are arranged on different planes, perpendicular to the hub of the drive wheel. This means that, in general, maximum one pinion is arranged on the same plane as the sprocket. Therefore, in general, the links of the transmission chain are not coplanar; contrariwise, they are arranged at an angle with respect to one another, wherein however the optimal operative condition for a transmission chain is that the links are aligned on the same plane. The arrangement described above causes significant friction between the links and causes therefore a loss of transmission power, that is greater or smaller in the various gears, as well as noise and wear, with loss of transverse rigidity, which requires frequent maintenance operations and jeopardizes the transmission functionality.

Another drawback of the derailleur gear systems is that it is impossible to switch quickly and/or directly from a gear to another, non-consecutive gear. This is disadvantageous in terms of vehicle performances, above all in case of sudden and steep slopes along the road.

Moreover, the derailleur systems does not allow to change gear when the vehicle is still, nor to start a climb having already selected the right gear.

To solve the problems mentioned above gear switching devices have been developed constituted by a cassette containing the gears, integrated in the hub of the drive wheel, that is typically the rear wheel, or in the central shaft. These devices comprise a plurality of toothed gears, each of which corresponds to a given gear ratio; all the toothed gears are arranged along an own axis, therefore they have a shape particularly elongated according to the direction of the axis. These devices have however numerous drawbacks.

The devices integrated in the hub-wheel are not suitable for retrofit, i.e. they cannot be mounted in existing vehicles, in particular for renewing vehicles based on old techniques. In fact, in these vehicles it is necessary to replace the existing wheel, where the devices shall be installed, with a suitable wheel, or to modify it, which is very difficult for a user to do. Moreover, the new hub with the integrated transmission replaces the normal hub and becomes part of the wheel; therefore, in case of damages to the wheel, the fast recovery of wheel and transmission is possible only having available a second wheel provided with transmission, and this significantly increases the related costs.

Moreover, the whole weight of the devices integrated in the hub-wheel is loaded on the rear wheel, thus reducing the vehicle dynamic balance.

On the other hand, for installing the devices integrated in the central shaft a specifically designed frame is required; for this reason, these devices can be replaced only with identical devices, thus limiting the user's freedom of choice. And, for the same reason, these devices do not allow retrofit.

Moreover, both with the devices integrated in the hub-wheel and with those integrated in the central shaft, of the type mentioned above, it is disadvantageous and even impossible to install a motor for a pedal-assisted vehicle, above all due to the axial bulk of the transmission devices, due to the arrangement along the axis of the toothed gears corresponding to the different gear ratios.

In fact, the known transmission devices to be installed in the hub of the drive wheel completely occupy the space that is usually used to install the motor, and it is therefore necessary to use a less common and more expensive motor that can be installed on the central axis or on the other wheel, typically the front wheel. On the other hand, the devices integrated in the central axis do not allow the integration with a coaxial motor as the resulting integrated device would be too long for being arranged between the pedals. For this reason, the motor shall be installed in correspondence of the hub of the drive wheel, typically the rear wheel, with analogous problems in terms of weight and loads distribution on the vehicle, problems that are even worsened in case the electric battery is mounted above the drive wheel.

U.S. Pat. No. 3,727,484 discloses a transmission for bicycles configured to be installed on the bottom bracket of a bicycle. The transmission comprises a multiple epicyclical gear train, comprising three concentric sun gears keyed on the shaft or pin of the cranks, three series of satellite gears and three outer gears or sprockets. These components substantially form three distinct epicyclical gear trains. The gear ratio is modified by selecting any one of the three epicyclical gear trains. This transmission is particularly complex and bulky. In fact, the need for arranging three epicyclical gear trains on an axis means a significant axial bulk. Moreover, if you want to increase the number of gear ratios, it is necessary to increase the number of epicyclical gear trains, and this in turns increases the axial bulk of the transmission device.

WO2011/142562 discloses a fixed-ratio epicyclical gear train, mounted on the spindle of a bottom bracket of the bicycle to have a better acceleration. This device does not allow gear switching.

DE 740086 discloses a transmission for vehicles, comprising a plurality of coaxial toothed gears keyed on a common shaft and a plurality of auxiliary shafts parallel to the common shaft, on which two auxiliary toothed gears are keyed. This transmission device is bulky and not suitable to be used on human-powered vehicles.

There is therefore a need for a transmission, especially although not exclusively for human-powered vehicles, that completely or partially, overcomes at least one of the drawbacks of the transmissions of the background art.

### SUMMARY

The object of some embodiments of the embodiments disclosed herein is to provide a human-powered vehicle equipped with a transmission system allowing to keep the transmission chain or belt aligned with a plane, independently of the selected gear ratio, and also allowing to switch quickly and/or directly from a gear ratio to another non-consecutive gear ratio, in particular allowing direct switching between the highest and the lowest gear ratio, and to pre-select the desired gear ratio before starting riding, in particular to pre-select a gear suitable for climbing.

A particular object of some embodiments is to provide such a transmission device, which is easy to install, in particular that can be easily installed on an existing vehicle, i.e. that is suitable for retrofitting.

A further object of some embodiments is to provide a transmission device having reduced dimensions compared to the prior art devices, in particular such as to facilitate the installation of a motor for pedal-assisted vehicles.

A further object of some embodiments is to provide a transmission device that has a limited weight compared to the prior art devices.

Another object of some embodiments is to provide such a vehicle, typically a pedal-assisted vehicle, for instance with an electric motor, that allows to load the weight of the transmission and of the motor mainly on the central part of the vehicle.

A further object of some embodiments is to provide an assisted pedal vehicle that allows to mount a motor, for example an electric motor, integrated in a single casing in the space between the pedal cranks, wherein the transmission device and the motor are coaxial with each other.

According to an aspect, to solve or overcome, at least partially, the drawbacks of the prior art transmission devices described above, a transmission device is provided, here below referred to simply as “transmission”, that comprises a support where an input central shaft is rotatably supported. The transmission also comprises a central wheel, connected to the central shaft and rotating therewith, and an output wheel. A rotary unit is also provided, rotatably supported by the support around a rotation axis thereof to take a plurality of angular positions. A plurality of selectable gear pairs are arranged on the rotary unit, each pair being rotatably mounted on the rotary unit. A rotation mechanism of the rotary unit is configured to bring the rotary unit into one of the angular positions, selectively. In each angular position of the rotary unit the respective selectable gear pair transmits motion from the central wheel to the output wheel. Each selectable gear pair is configured to provide a different gear ratio between the central wheel and the output wheel.

Each selectable gear pair gives a gear ratio. Having a rotary unit of sufficient dimension it is possible to have an even high number of selectable gear pairs without however increasing the axial bulk of the transmission device. Moreover, as it will be clearly apparent from the detailed description of embodiments, if the transmission is installed on a bicycle or on other human-powered vehicle using a continuous flexible member, such as a chain or a belt, for transmitting motion to the drive wheel, the switching of the gear does not entails a change in the lying plane of the continuous flexible member.

According to some embodiments of the invention, it is possible to change the gear ratio also when the vehicle is still. It is also possible to switch from any gear ratio to any other, not necessarily to an immediately preceding or immediately following one; in this way it is possible to achieve a greater functionality of the transmission.

In advantageous embodiments, each selectable gear pair comprises a respective primary gear and a respective secondary gear. In advantageous embodiments, the ratio between the diameter of the primary gear and the diameter of the respective secondary gear differs between the selectable gear pairs, so as to define a different gear ratio for each selectable gear pair.

In some embodiments of the invention, in order to have a compact and mechanically reliable configuration the rotary unit comprises two parallel rings mounted perpendicularly to the central shaft. In this case, the selectable gear pairs may be arranged between the two rings, with the respective rotation axes perpendicular to the rings.

A different configuration is also possible, for example with only one ring; in this case the primary gear and the secondary gear of each selectable gear pair are arranged on opposite sides of the ring, or they are both arranged on one side in a cantilevered fashion.

In some embodiments, the rotation mechanism comprises a switching unit suitable selectively to perform a switching movement and to make the rotary unit angularly displace around the rotation axis thereof so as: to disengage a currently selected one of said selectable gear pair (i.e. a currently working gear pair) from a mechanical transmission between the central wheel and the output wheel; and to make a further selectable gear pair, different from the current selectable gear pair, engage the mechanical transmission between the central wheel and the output wheel.

In some embodiments, an actuator unit is provided for controlling the switching movement of the switching unit. The switching unit may comprise, for example, a switching wheel provided with a switching pin that axially projects from an eccentric position of said switching wheel and is suitable to engage the rotary unit. The rotary unit may be provided with a plurality of radial grooves, the number of which is equal to the number of selectable gear pairs and which are arranged around the rotation axis of the rotary unit uniformly angularly spaced from each other by a fraction of a 360° angle and which are suitable to engage the switching pin of the switching wheel; so that a rotation of the switching wheel makes the switching pin engage one of the radial grooves and, as the rotation continues up to a complete turn, the switching pin makes the rotary unit rotate by an angle equal to the round angle (360°) divided by the number of selectable gear pairs.

Further advantageous features and embodiments of the transmission will be set forth in the description below and in the attached claims, which form an integral part of the present description.

According to a further aspect, a human-powered vehicle is provided, for example, although without limitation a bicycle, wherein a transmission, of the type described above and better detailed below, is associated to the central movement.

The present disclosure specifically concerns also a human-powered vehicle comprising:
a frame;
a central shaft, which is arranged rotatable with respect to the frame and at the ends of which pedals are connected through respective cranks;
at least one drive wheel arranged rotatable with respect to the frame, the drive wheel having a drive element;
a motion transmitting member for transmitting a rotation of the central shaft to the drive element of the drive wheel;
   whose main characteristic is to comprise also a transmission device comprising:
a support integral with the frame rotatably supporting the central shaft, so that the transmission device has an input shaft coinciding with the central shaft;
an rotatable output element rotatably supported by the support,
   wherein the motion transmitting member engages between the rotatable output element and the drive element;
   wherein the transmission device is arranged between the vehicle frame and one of the pedal cranks.

The human-powered vehicle may be any vehicle powered through pedals, such as bicycles, bike taxis, tricycles, quadcycles, torpedo bikes, urban rickshaws, tandems, even actuatable by means of handles.

The term “pedals” refers to pedals of the traditional type, and also to equivalent devices actuatable by a user with his/her arms, for example handles.

The transmission member may be a transmission chain, and in this case the rotatable output element and the drive element of the drive wheel form a conventional sprocket-pinion pair. In these cases, the transmission device according to the invention allows the chain to move constantly aligned, i.e. arranged on a same plane parallel to the frame, thus maximizing the transmission efficiency and minimizing the wear of the transmission member.

The transmission member may be also a belt, preferably a toothed belt, or a different belt, for instance a trapezoid belt, transmitting motion by friction on the output elements and the drive elements, that are, in this case, a pair of pulleys, in the first case toothed pulleys.

The transmission member may be also different than those mentioned above; in particular, the transmission may comprise a transmission shaft.

The contact areas between the device according to the invention and the remaining part of the vehicle are only the points where the support of the transmission device is fastened to the frame, in order to make the support integral with the frame, and the contact point between the output element, i.e. the sprocket or the equivalent pulley, and the transmission chain or belt. The central shaft is integrated with the device, and the other members that contact it, i.e. cranks and pedals, do not have any contact point with the vehicle. With this kind of structure, the installation on a new vehicle or on an existing vehicle requires no much more work than the simple replacement of the central shaft. This allows greatly to simplify the mounting operation of a new vehicle, thus reducing the necessary time and costs; the vehicle can even have a frame of traditional shape in the area of the central axis, suitable for the installation of a normal transmission system comprising one or more sprockets and pinions, and a chain therebetween. Also the installation on an existing vehicle is simpler, for example for replacing a traditional transmission system already mounted on the vehicle, as there is no need for modifying the vehicle.

Moreover, in the transmission structure, the gear ratios are selected by making the output element, in particular the pulley or the sprocket, engage directly or indirectly respective selectable gear pairs arranged around a central axis, therefore parallel to one another and limited between planes perpendicular to the axis. In this way it is possible to have a limited bulk of the transmission device compared to other devices of the prior art that allow keeping the chain or belt always parallel to itself. Also thanks to this feature the transmission device is suitable for being installed on vehicles without any restrictions as regards the shape of the frame and without the need for onerous or even impossible modifications thereof.

The limited axial bulk of the transmission device according to the invention also allows introducing a pedal assist motor, coaxial with and advantageously integrated with the transmission device, all arranged in the space comprised between the cranks of the human-powered vehicle. In this way it is possible to overcome the limits and the disadvantages the known transmission devices have as regards the installation of motors.

In fact, contrariwise to the prior art transmission devices to be installed both in the hub-wheel and on the central axis, with the present invention it is not necessary to arrange masses on the hub of the drive wheel. Moreover, the weight of an integrated transmission-motor device according to the invention is lower than the sum of the weight of a known transmission device for hub-wheel or central axis and the weight of a motor for central axis and hub wheel respectively. Briefly, the invention allows to have a vehicle that is provided with both a transmission device and a motor, and has a lower weight, distributed in a more balanced way with respect to the prior art devices.

In particular, the transmission device comprises:
a central wheel constrained to the central shaft;
an output wheel constrained to the output element, i.e. the sprocket, or with the output pulley for the transmission chain, or a gear, arranged so as to transmit a rotary motion to the rotatable output element;
a plurality of selectable gear pairs, each of which is mounted rotatable on a rotary unit rotatably mounted for rotation around a respective rotation axis with respect to the support;
a rotation mechanism of the rotary unit, configured to make the central wheel and/or the output wheel engage selectively the selectable gear pairs, so that only one selectable gear pair meshes with the mechanical transmission that contemporaneously engages both the central wheel and the output wheel,
   each selectable gear pair being configured to provide a different gear ratio between the central wheel and the output wheel.

In an embodiment, the rings may be fastened together by means of one or more stiffening longitudinal elements arranged to prevent the two rings from rotating with respect to each other around the axis of the rotary unit.

In an embodiment, the output wheel is external with respect to the rotary unit and meshes selectively with only one selectable gear pair, and the rotary unit is arranged eccentric with respect to the central wheel, so that only a selected one of said selectable gear pairs meshes with both the central wheel and the output wheel. In this way, each selectable gear pair engages the central wheel only when the corresponding gear is selected, and therefore only the selectable gear pair corresponding to the selected gear rotates, whilst the other pairs remain still. This allows limiting friction, thus increasing the efficiency and decreasing the noise produced by the device, as well as the wear thereof.

In a further embodiment, the output wheel is again external with respect to the rotary unit and selectively meshes with only one of the selectable gear pairs, and the rotary unit is arranged coaxial with respect to the central wheel so that all the selectable gear pairs simultaneously mesh with the central wheel. In this way a significant simplification of the construction is achieved.

In a further embodiment, the output wheel is concentric with the rotary unit, and the central wheel meshes with the selectable gear pairs through an intermediate gear, the output wheel, integral with the output rotatable element, being provided as an internal wheel with respect to the output rotatable element. In this way, the radial bulk of the device is contained within the outer circumference of the output element. This allows having a device of limited bulk, and above all with a symmetric profile distribution, what is useful in case of vehicles where the appearance and the look are very important.

In particular, the central wheel engages the selectable gear pairs through an intermediate gear comprising a first intermediate wheel that meshes with the central wheel and a second intermediate wheel that can mesh selectively with each selectable gear pair through the rotation mechanism.

Advantageously, the rotation mechanism comprises a switching unit configured selectively to perform a switching movement and to make the rotary unit angularly displace around the axis by an integer multiple of a fraction of an angle of 360° based on the number of selectable gear pairs, so as:
to disengage a currently selected one of said selectable gear pairs from at least one of the central wheel and the output wheel; and
to make a further selectable gear pair, different from the currently selected gear pair, engage the at least one of the central wheel and the output wheel.

An actuator unit is provided to actuate the switching movement of the switching unit; the actuator unit can be manual, equipped with an actuation control, or servo-assisted, i.e. equipped with a servomotor, typically an electric motor, having control buttons, the actuation control or control buttons being preferably arranged on a handlebar of the human-powered vehicle.

Preferably,
the switching unit comprises a switching wheel provided with a switching pin, herein referred to also as drawing member, axially projecting from an eccentric position of the switching wheel;
the rotary unit is provided with a plurality of radial peripheral grooves, the number of which is equal to the number of selectable gear pairs, which are uniformly angularly spaced by said fraction of an angle of 360°, equal to 27 divided by the number of selectable gear pairs, and which are configured to receive the switching pin,
   so that a rotation of the switching wheel makes the switching pin engage one groove and, as the rotation continues, the switching pin make the rotary unit rotate.

In particular, the switching unit comprises a coupling toothed gear having a longitudinally incomplete coupling/decoupling tooth, and the actuator unit is configured to cause a translation of the coupling toothed gear, so that
the coupling/decoupling tooth meshes with the central wheel or an auxiliary wheel rotatably actuated by the central wheel, so that the central wheel, when rotating, drives the coupling toothed gear into rotation;
the coupling/decoupling tooth disengages from the central wheel or from the auxiliary wheel when the coupling wheel has done at least one turn, i.e. when the rotary unit has rotated by the fraction of an angle of 360°, or by the integer multiple of the fraction of the 360° angle, stopping the coupling toothed gear,
   wherein the coupling toothed gear and the switching wheel are coupled to one another in the switching unit such that the coupling wheel, when rotating/stopping, causes the rotation/stop of the switching wheel.

In this way, the actuation of the actuation device, combined with the user pedaling, makes a first selectable gear pair disengage from the central wheel, where it is directly or indirectly engaged, and/or from an output unit comprising an output wheel and the output element, and makes a new selectable gear pair engage directly or indirectly the central wheel and/or the output unit, causing the change i.e. the switching of the gear. Moreover, it is possible to pass from a gear to any other, i.e. switching from a given gear to another gear, even if not consecutive. This allows to switch from one gear ratio to another in a simple way, without the rider requiring particular attention or stopping pedaling, such that an optimal gear ratio can be selected also in case of sudden change in the road slopes.

In particular, elastic return means for returning to the normal running position are associated with the coupling toothed gear so that, by actuating the actuator unit without retaining it, the coupling toothed gear and the switching wheel make only one turn up to a position where the longitudinally incomplete tooth disengages, and therefore the rotary unit rotates by only a fraction of a 360° angle, causing the switching from a given transmission ratio to a contiguous transmission ratio.

Advantageously, the switching unit comprises at least one blocking element integral therewith, and the rotary unit is provided with a plurality of peripheral recesses that are uniformly angularly spaced from each other by the fraction of an angle of 360° and are configured to engage the blocking elements, the blocking elements being suitable to disengage the peripheral recesses when the switching unit causes the rotation of the rotary unit.

Preferably, said at least one blocking element is integral with the switching wheel and is arranged at a given angular position with respect to the switching pin, and the peripheral recesses are angularly offset with respect to the peripheral grooves by an offset angle such that when the switching pin engages the radial groove controlling the rotary unit, during the rotation of the switching wheel, the blocking elements disengage the peripheral recesses of the rotary unit.

In particular, the peripheral recesses are provided in correspondence of an edge of at least one of the two rings, so as to facilitate the engagement with the blocking element.

The peripheral recesses are preferably provided in correspondence of an edge of each ring, in corresponding angular positions of the two rings. This is necessary especially when the two rings of the rotary unit are not constrained to each other through the longitudinal stiffening elements mentioned above but are only slightly constrained to each other through the selectable gear pairs and therefore, when they are subjected to respective tangential loads generated by the radial loads of the toothing of the working selectable gear pair, if kept in position through a single blocking element, they could make a give rotation around the common axis, i.e. around the axis of the rotary unit.

The manual actuator unit may comprise a cable, fastened
at a first end to the control element so as to receive a traction therefrom, and
at the second end, to an actuation element provided to cause, through traction, the switching movement of the switching unit.

In an embodiment, the second end of the cable is torsionally constrained to the switching unit so that, when the switching unit angularly displaces the rotary unit, the cable is subjected to a torsion depending on the angular displacement.

A display device is also provided for displaying the current gear, wherein an index, connected to the first end, is provided to make a displacement depending on the torsion, so as to show a symbol indicating the current gear.

In this way, the traction cable and the whole actuator unit transfer the information on the performed gear ratio switching to the display device. This allows to use the same kinematic chain both to transmit the actuation movements of the transmission device, in a direction of the cable, and reliably to receive from the transmission device a confirmation of the actuation, in the opposite direction, exploiting at the best the mechanical transmission properties of the cable and limiting the complexity of the device with respect to a return system separated from the actuator unit.

In some embodiments, the transmission device comprises an auxiliary pedal assisting motor. In some embodiments, the auxiliary motor comprises a rotor integral with the central wheel and a stator integral with the support, so as to transmit a rotary motion to the central wheel, also as a factor of sum of the motion imparted to the device by the user through the central shaft. In this way it is possible to have a modality of torque supply—on, off, modulation—that can be adapted to the specific local regulations, as the overall torque can be provided as the sum of the torque transmitted by the user through the pedals and the torque generated by the motor, or only as the torque generated by the motor, notwithstanding the possibility for the rider of actuating the vehicle through the pedals in a completely autonomous way.

The vehicle may comprise:
a detector for detecting the rotation direction of the central shaft, configured to emit a signal indicating it;
a control unit configured to receive the signal indicating the rotation direction, and to enable the rotation of the auxiliary motor also in case of rotation of the central shaft in a direction opposite to the running direction of the vehicle,
   so as to allow switching the gear also when pedaling in opposite direction with respect to the vehicle running direction.

In particular, the rotor comprises permanent magnets integral with the central wheel, and the stator comprises electrical windings integral with the support.

### BRIEF DESCRIPTION OF THE DRAWINGS

The invention will be explained below by means of the description of some embodiments thereof, given just by way of non-limiting examples, and with reference to the attached drawing, where:

FIG. 1 is a schematic top view of a bicycle provided with the transmission device according to the invention;

FIGS. 2-3-4 are partial side views of bicycles provided with manually operated transmission devices according to three different embodiments of the invention, respectively indicated as eccentric, semi-coaxial and coaxial;

FIGS. 5 and 6 are perspective views of the transmission device shown in FIG. 2;

FIGS. 7 and 9 respectively show a schematic cross-sectional side view and a schematic cross-sectional top view of the mechanism of the eccentric transmission device of FIG. 2;

FIG. 8 shows a detail of a variant of the device of FIG. 7, wherein the motion transmission member is a toothed belt instead of a chain;

FIG. 10 is a cross-sectional view of a detail of a rotatable output element for the embodiment of FIG. 8;

FIG. 11 is a partial cross-sectional view of the device of FIGS. 7 and 9;

FIGS. 11a and 11b are local cross-sections according to the lines I-I and II-II of FIG. 11;

FIGS. 12-13-14-15 show the device of FIG. 2 in a sequence of gear ratio switching steps;

FIGS. 16-17-18-19 show the steps of changing the position of the transmission control corresponding to the steps shown in FIGS. 12-15;

FIGS. 20 and 21 are respectively a schematic cross-sectional side view and a schematic cross-sectional top view of the mechanism of the semi-coaxial transmission device of FIG. 3;

FIG. 22 is a partial cross-sectional view of the device of FIGS. 20 and 21;

FIGS. 23 and 24 show respectively a schematic cross-sectional side view and a schematic cross-sectional top view of a modified embodiment of the device of FIGS. 20 and 21 provided with electric servo-assisted control;

FIGS. 25 and 26 show respectively a schematic cross-sectional side view and a schematic cross-sectional top view of a embodiment of the device of FIGS. 20 and 21 provided with a pedal-assist motor;

FIGS. 27 and 28 are perspective views of the transmission device according to a variant of the embodiment of FIG. 2, provided with an electric motor;

FIGS. 29 and 30 are respectively a schematic cross-sectional side view and a schematic cross-sectional top view of the mechanism of the coaxial transmission device of FIG. 4;

FIGS. 31 and 32 are partial cross-sectional views of the device of FIGS. 29 and 30;

FIGS. 33 and 34 are alternative electric diagrams of a device according to the previous figures, in a variant providing respectively for only the electric servo-assisted control and both the electric servo-assisted control and the motor;

FIGS. 35 and 37 are cross-sectional views of a control arranged on the handlebar with a gear indicator;

FIG. 36 is a top view of the control of FIGS. 35 and 37;

FIGS. 38-47 are schematic top views of the embodiments of FIGS. 2-4, in different embodiments.

### DETAILED DESCRIPTION OF THE INVENTION

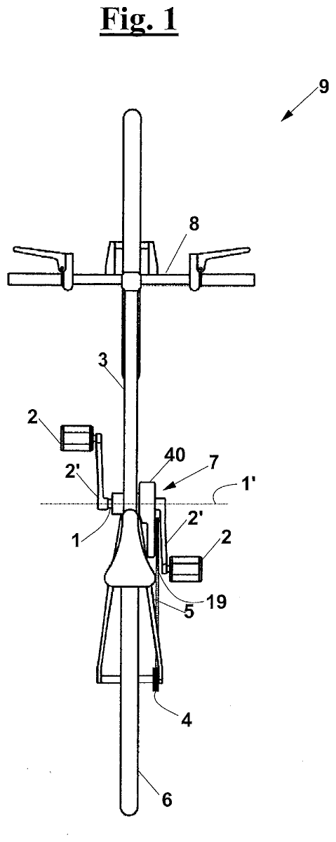

With reference to FIG. 1, a human-powered vehicle 9 is described, for instance a bicycle, comprising a transmission device 7 for changing the gear ratio between a central shaft 1 and a drive wheel 6 through a transmission member 5. The vehicle 9 comprises a frame 3 rotatably supporting the central shaft 1 through a support 40 of the transmission device 7, from which an output rotatable element 19 projects. Also, the frame 3 rotatably supports a drive wheel 6, the hub whereof is integral with a drive element 4 provided with freewheel, as described below.

Even if the description below is made only with reference to a bicycle 9, it is understood that it also applies, obviously with the necessary modifications, to any human-powered vehicle actuated through pedals or handles, such as bike taxis, tricycles, quadcycles, torpedo bikes, urban rickshaws, tandems.

Moreover, without limiting the general scope of the disclosure, reference will be made in the description to the case where the transmission member 5 is a chain, and therefore the output and drive elements are respectively a sprocket 19 and a pinion 4. However, any other transmission member may be provided for transmitting motion from the pedals to the wheel 6. In an embodiment, not shown, the transmission member 5 is a belt and the output and drive elements 4, 19 are pulleys, in particular a toothed belt mounted between toothed pulleys. In a further embodiment, not shown, the transmission member 5 comprises a drive shaft, for instance a cardan shaft.

Preferably, even if not mandatory, the support 40 is shaped like a box or casing, as shown in the figures.

Respective pedals 2 are mounted, through pedal cranks 2′, at the end of the shaft 1; through the pedals the shaft receives the rotary motion imparted by the user. According to the invention, the transmission device 7 is mounted between the central shaft 1 and the transmission chain 5. More precisely, the transmission device 7 is arranged between the frame 3 and one of the pedals 2, and has a drive shaft coinciding with the central shaft 1, while the output wheel or sprocket 19 meshes with the chain 5.

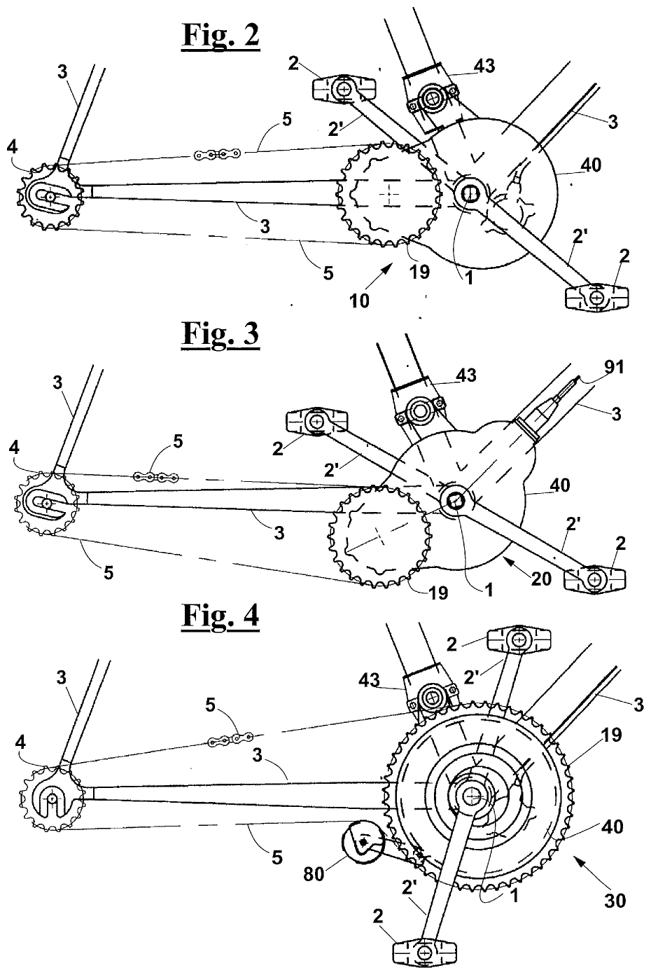

FIGS. 2, 3 and 4 are schematic partial side views of the bicycle 9 provided with transmission devices 10, 20, 30 according to three different embodiments of the invention, better detailed below.

### First Embodiment

FIG. 2 refers to an eccentric embodiment of the device 10, shown in greater detail in FIGS. 5 to 11.

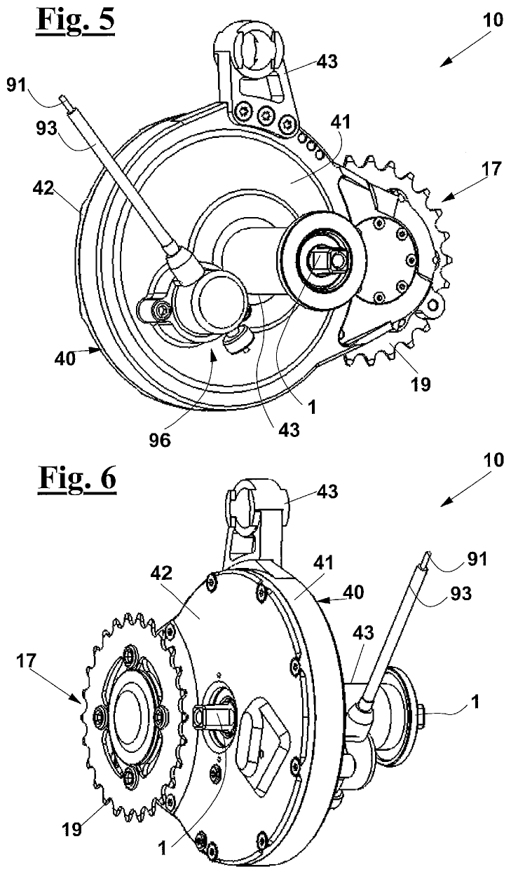

As shown in FIGS. 5 and 6, the casing 40 of the device 10 comprises fastening means 43 for fastening to the frame 3. Advantageously, the casing 40 has a substantially cylindrical shape, and is preferably formed by two halves 41 and 42 that can be demounted from each other, for instance a base 41 and a cover 42. The central shaft 1 protrudes centrally from the casing 40. Furthermore, an output unit 17 is arranged outside the casing 40. The output unit 17 comprises the output sprocket 19 and is arranged laterally with respect to the central shaft 1, the output sprocket 19 being arranged outside the casing 40 at the side of one of the two halves 41 and 42, in this case at the side of the cover 42, in particular parallel to this half-casing.

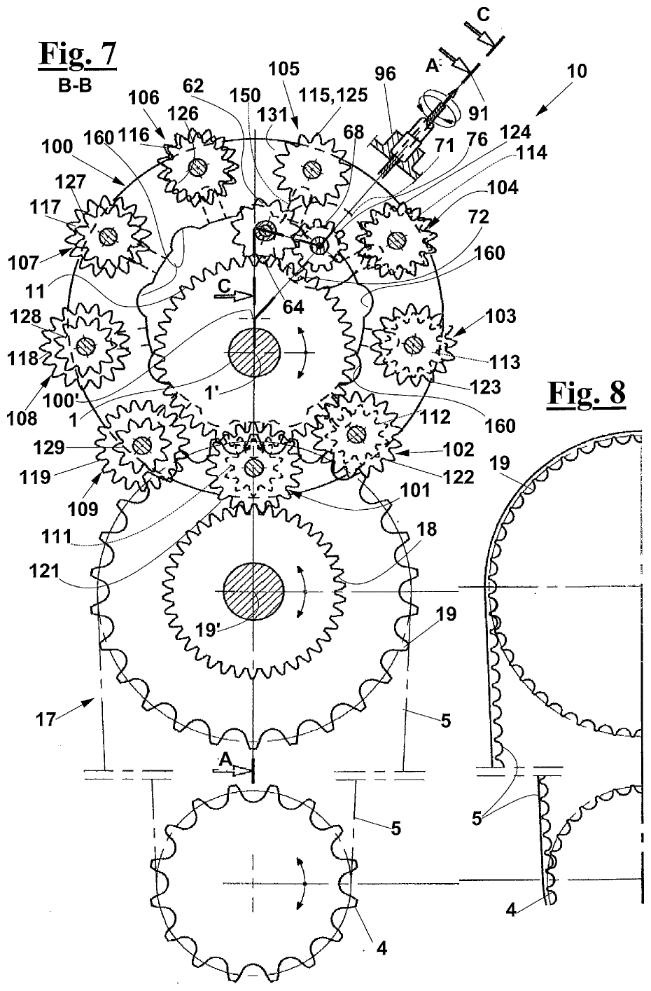

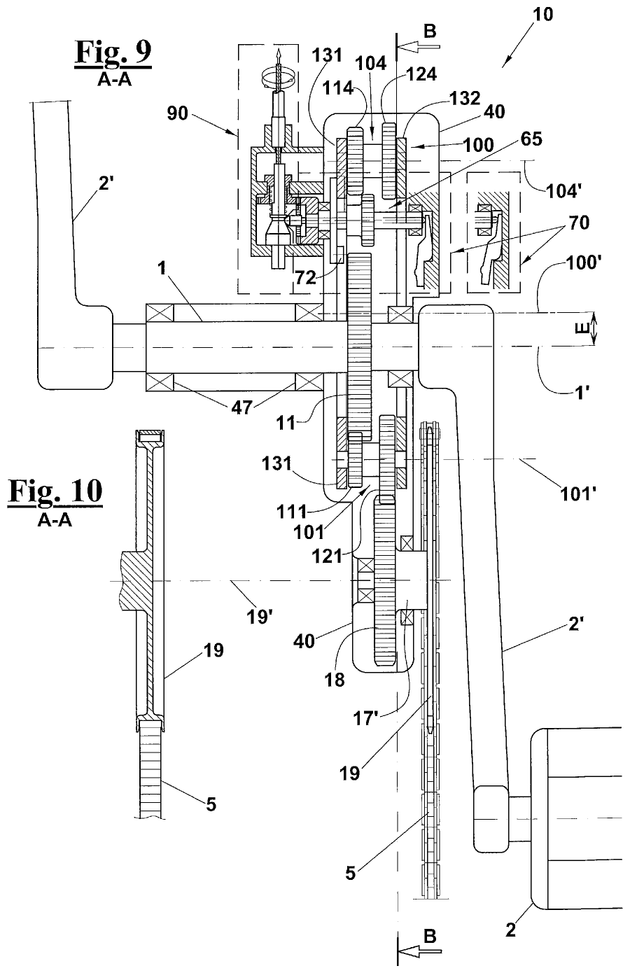

As shown in FIGS. 7 and 9, the device 10 comprises a central wheel 11, which is keyed to the central shaft 1 connected to the support or casing 40 through bearings 47, and a rotary unit 100, on which selectable gear pairs 101-109 are mounted rotatable with respect to the rotary unit 100 around respective rotation axes 101′,104′ and the like.

Advantageously, the rotary unit 100, seen from the side as in FIG. 7, is shaped like a circular wheel. Seen from the top, as in FIG. 9, the rotary unit 100 advantageously comprises two parallel rings 131 and 132 which are mounted perpendicularly to the central shaft 1 and between which the selectable gear pairs 101-109 are arranged with the respective rotation axes perpendicular to the two rings 131,132. In a portion of the space comprised between the two rings 131 and 132 the central wheel 11 is also provided.

In this case, the number n of selectable gear pairs is nine, corresponding to a same number of gear ratios between the central shaft 1 and the wheel 6 (FIG. 1). The selectable gear pairs are angularly spaced from one another by a distance equal to a fraction 2π/n of an angle of 360°, said fraction being defined by the number of selectable gear pairs; in this case the selectable gear pairs 101-109 are arranged at 40° from one another.

The central wheel 11 and the rotary unit 100 are arranged with the respective axes 1′ and 100′ parallel to each other, and spaced from each other by a distance E (FIG. 9). The diameter of the central wheel 11, the distance E and the position of the selectable gear pairs 101-109 with respect to the axis 100′ of the rotary unit 100 are selected such that the central wheel 11 can selectively mesh with only one selectable gear pair. In the case of FIGS. 7 and 9, the central wheel 11 engages the selectable gear pair 101, directly meshing therewith.

An integral guide, not shown, is arranged inside the casing 40 so as to allow a rotation of the rotary unit 100 with respect to the casing 40 and, therefore, with respect to the frame 3 (FIG. 2). Due to to a rotation of an angle 2π/n, or to an integer multiple m2π/n thereof, starting from the position shown in FIG. 7, the central wheel 11 can selectively mesh with each selectable gear pair 101-109.

Each selectable gear pair comprises a primary gear 111-119, and a secondary gear 121-129, parallel to one another, integral with an intermediate hub portion and spaced apart from one another by said intermediate hub portion so as to be adjacent to the rings 131 and 132 of the rotary unit 100 respectively. In particular, the primary gears 111-119, on the one hand, and the central wheel 11, on the other hand, are arranged so that the central wheel 11 can selectively engage each primary gear 111-119, transferring the rotation of the shaft 1 to the respective selectable gear pair 101-109 and making this rotary motion available through the respective secondary gear 121-129.

As shown in FIG. 7, the ratio between the diameter of the primary gear 111-119 and the diameter of the secondary gear 121-129 differs between the selectable gear pairs, so as to define a different gear ratio of the device 10 for each selectable gear pair 101-109. In more detail, this ratio can be lower than 1 and increasing for a group of adjacent selectable gear pairs 101-104 and greater than 1 and increasing for another group of adjacent selectable gear pairs 106-109, and, if necessary, it can be also substantially equal to 1 for a selectable gear pair 105.

With reference to FIGS. 7 and 9 again, the output unit 17, rotatable around the rotation axis 19′, comprises, in addition to the output sprocket 19, an output wheel 18 coaxially connected to the output sprocket 19, around the axis 19′, by means of an intermediate hub portion 17′, and therefore integral with the output sprocket 19.

As shown in FIG. 7, when the rotary unit 100 is in a position where the central wheel 11 meshes with the primary gear 111 of a given selectable gear pair 101, the secondary gear 121 of the selectable gear pair 101 meshes with the output wheel 18, allowing to transfer the motion from the central shaft 1 to the wheel 6 according to a gear ratio that depends on the ratio between the diameters of the primary gear 111 and secondary gear 121.

By rotating the rotary unit 100 around the axis 100′ thereof, along the guide means integral with the support or casing 40, by the angle m 2π/n, where m is an integer comprised between 1 and n−1, a corresponding selectable gear pair 102-109, not necessary adjacent to the selectable gear pair 101, engages the central wheel 11 and the output wheel 18, respectively through the respective primary gear 112 or 119 and through the respective secondary wheel 122 or 129, thus setting the desired gear ratio.

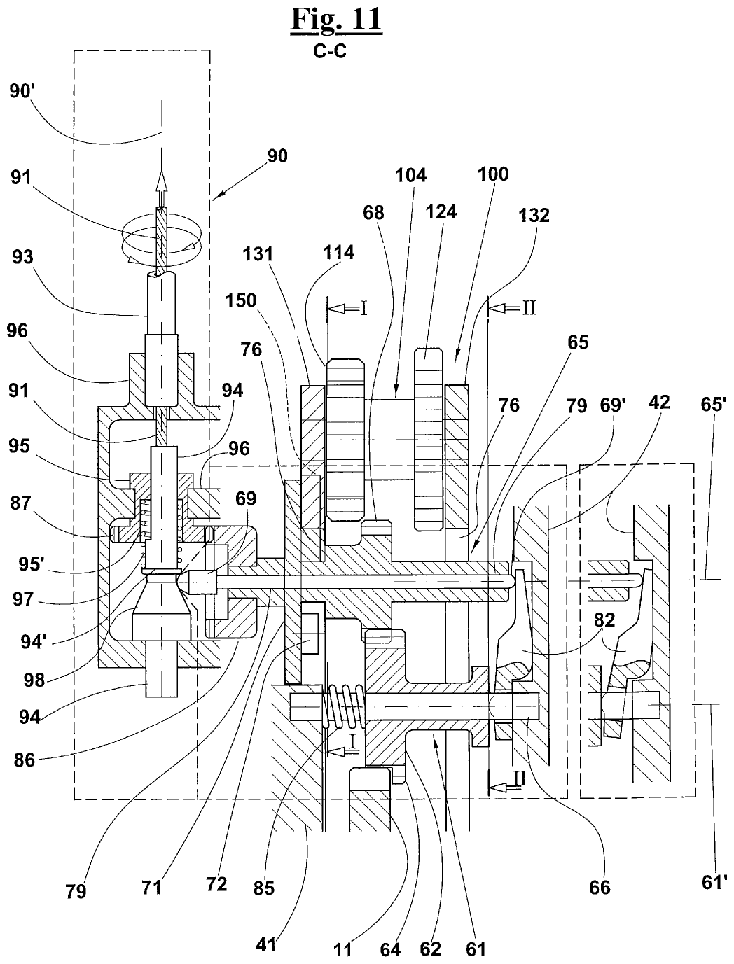

To this end, as shown in FIG. 9, and in more detail in FIGS. 11, 11a and 11b, a rotation mechanism of the rotary unit 100 is provided, comprising a switching unit 70 co-acting with an actuator unit 90. In the embodiment illustrated in FIG. 11, the switching unit 70 comprises a coupling toothed gear 62 and a switching wheel 71, respectively keyed to a primary switching shaft 61 and to a secondary switching shaft 65, typically parallel to each other.

Advantageously, the switching wheel 71 is mounted just outside the rotary unit 100 and parallel to the ring 131. The switching wheel 71 advantageously has, in a peripheral portion thereof, a drawing member 72 that can be configured like a switching protuberance or pin 72 projecting towards the ring 131. Herein, the drawing member 72 will be referred to as “switching pin” 72.

In this case, as shown in FIG. 7, the ring 131 of the rotary unit 100 is provided with a number of radial control grooves 150 equal to the number of the selectable gear pairs 101-109 that are preferably spaced from one another uniformly around the axis 100′ according to the above-mentioned angle 2π/n. Each control groove 150 is configured to engage the switching pin 72 allowing it to slide and rotate thereinside.

The coupling toothed gear 62 is advantageously provided with at least one coupling/decoupling tooth or incomplete tooth 64, i.e. a tooth realized in only one end portion along the height of the coupling toothed gear 62. Moreover, an auxiliary wheel or inversion wheel 68, meshing with the coupling toothed gear 62, is keyed to the secondary switching shaft 65.

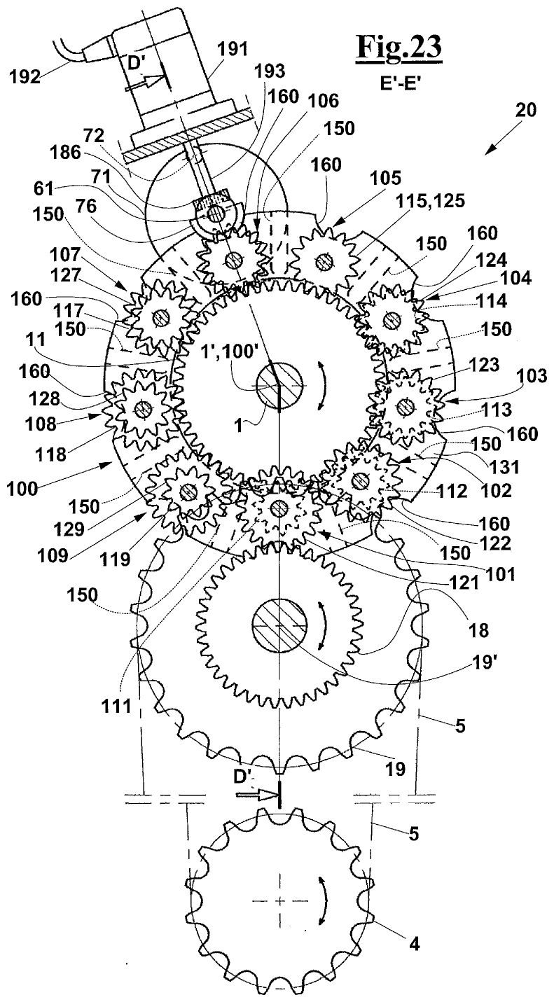

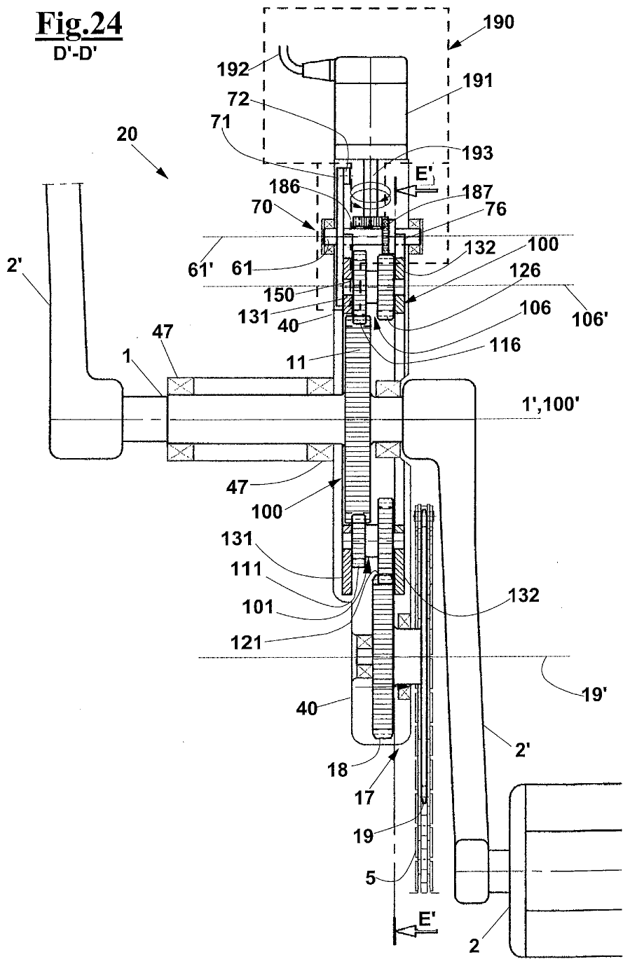

The actuator unit may be a manual actuator unit 90, comprising a traction cable 91 as in FIGS. 9 and 11, or a servo-assisted actuator 190, as described below with reference to a further embodiment of the device (FIGS. 23 and 24).

The manual actuator 90 is preferably actuatable through a control element 99 accessible by a user, such as a lever 99 arranged on the handlebar 8 of the vehicle (FIGS. 16 to 19 and 35-37), and configured to move axially the primary switching shaft 61.

In the embodiment of FIG. 11, the cable 91 has a proximal portion contained in a protective sheath 93, anchored to a support element 96 integral with the casing 40, and a distal end connected to a cursor 94 sliding through a seat such as a bush 95 axially fixed and rotatable with respect to the support element 96. Elastic return means 97 are provided between the bush 95 and the cursor 94. Said elastic return means 97 are arranged to return the cursor 94 to a given axial position with respect to the bush 95, when there is no more traction through the cable 91. In more detail, in this embodiment the cursor 94 and the bush 95 respectively have an end shoulder 94′ and a recess 95′ facing each other, wherein the recess 95′ may be an enlargement of a hole through which the cursor 94 slides when drawn by the cable 91; moreover, a compression spring 97, preferably arranged around the cursor 94, is mounted between the shoulder 94′ and the bottom of the recess 95′.

Advantageously, the cursor 94 comprises an element 98 with increasing cross-section, for instance a truncated-conical element 98 coaxial with the remaining part of the cursor 94, beyond and preferably near the shoulder 94′.

The secondary switching shaft 65 is provided with a central hole along the axis 65′ thereof, where a slidable pin 79 is inserted, whose end 69 is kept pressed against the surface of the element with increasing cross-section 98 by means of an elastic return device 85, described below, resisting the translation of the slidable pin 79 moving away from the element 98. The opposite end 69′ of the slidable pin 79 rests on an arm of a lever 82, hinged at an intermediate point or pivot point to the casing 40, or to an element integral therewith; the opposite arm of the lever rests on the primary switching shaft 61, mounted slidable along the axis 61′ around a fixed pin 66, that is in turn mounted between two portions 41 and 42 integral with the casing 40. In this way, by pulling the cable 91, which results in the slidable pin 79 translating away from the element 98, the lever 82 controls a displacement of the primary switching shaft 61 in opposite direction.

An elastic element 85 is arranged between the coupling toothed gear 62 and the portion 41 of the casing, for example a further compression spring 85, preferably around a portion of the fixed pin 66, in order to form, together with the primary switching shaft 61 and the lever 82, said elastic return device, thanks to which, when there is no more traction through the cable 91, the slidable pin 79 returns to the position it had before the traction, translating in opposite direction with respect to what described above. In more detail, the coupling toothed gear 62 is keyed to the primary switching shaft 61 in such a position that, by applying a traction to the cable 91, the gear translates integrally with the primary switching shaft 61, making the coupling/decoupling incomplete tooth 64 thereof engage the central wheel 11. In this way, the rotary motion imparted by pedaling to the central wheel 11 is transmitted to the coupling toothed gear 62 and to the primary switching shaft 61 and also, through the auxiliary wheel 68, to the secondary switching shaft 65, in opposite direction of rotation. Therefore, also the switching wheel 71, which is keyed to the secondary switching shaft 65, is driven into rotation around the axis 65′, and the switching pin 72 makes a revolution around the axis 65′. The rotation of the primary and secondary shafts 61 and 65 continues until the coupling/decoupling tooth 64 meets again the central wheel 11, i.e. it continues for a complete turn of the coupling toothed gear 62; then, this latter disengages from the central wheel 11 and stops. If, on the contrary, the user continuously pulls the cable 91 for a prolonged time beyond the duration of one turn of the coupling toothed gear 62, and therefore of the secondary gear 68, the coupling toothed gear 62 continues rotating until the coupling/decoupling tooth 64 meets the central wheel 11 for the first time after that the user has released the control element 99.

During this rotation, the switching pin 72 moves progressively towards an edge of the disc 131 of the rotary unit 100, and engages inside one of the control grooves 150 provided radially in the disc 131, making the rotary unit 100 rotate by at least the angle 2π/n, or more in general a multiple m 2π/n of said angle. The switching pin 72 and the control groove 150 are configured so that the pin disengages the groove, thus causing the rotary unit 100 to stop rotating around the axis 100′, when a selectable gear pair 102 or 109, adjacent to the selectable gear pair 101, that before engaged the central wheel 11, has engaged the central wheel 11. In this way a new gear ratio is set.

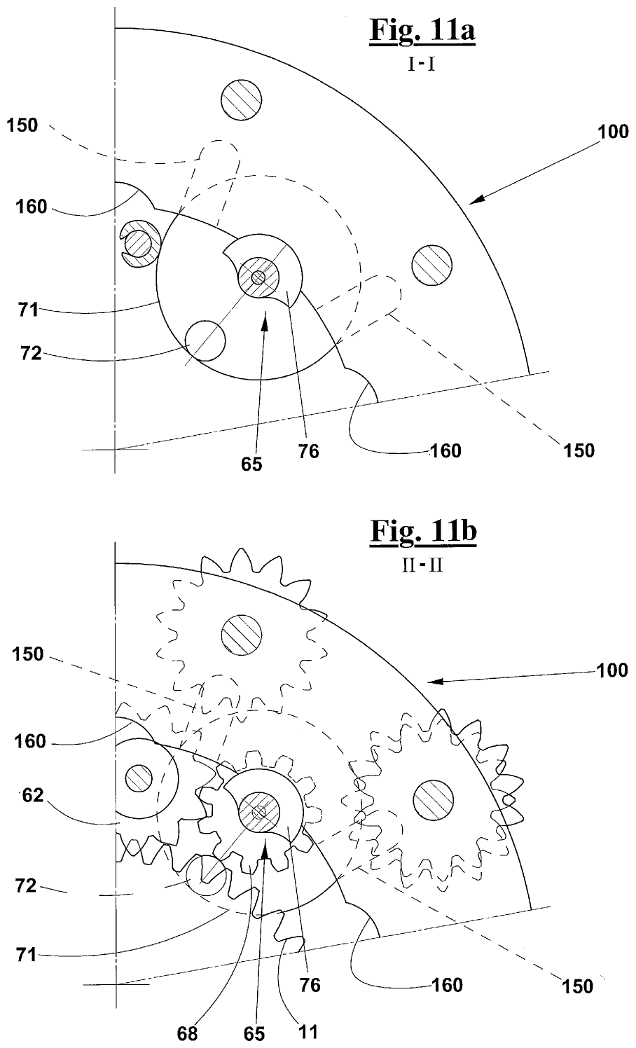

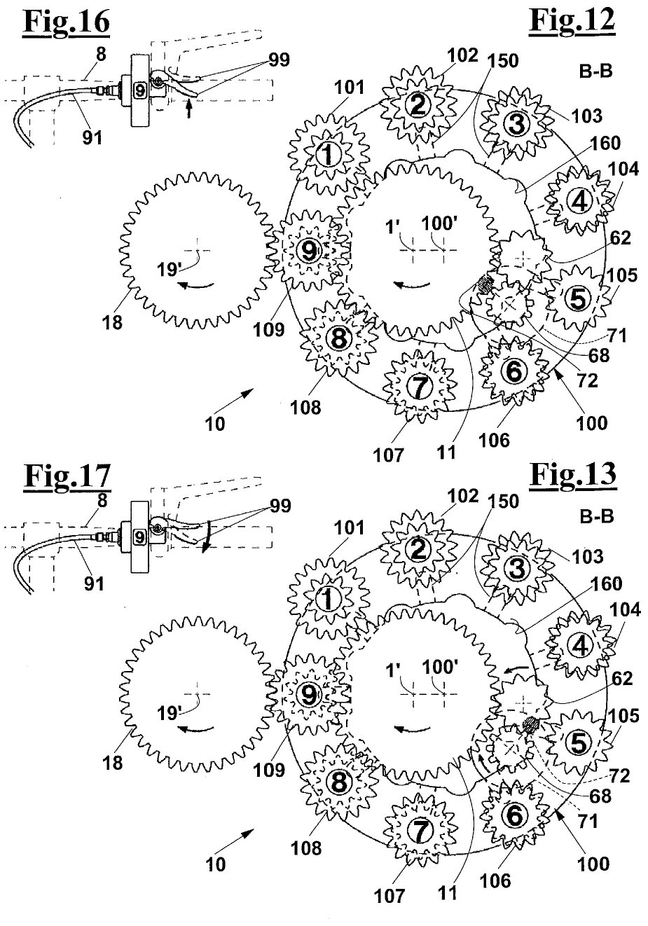

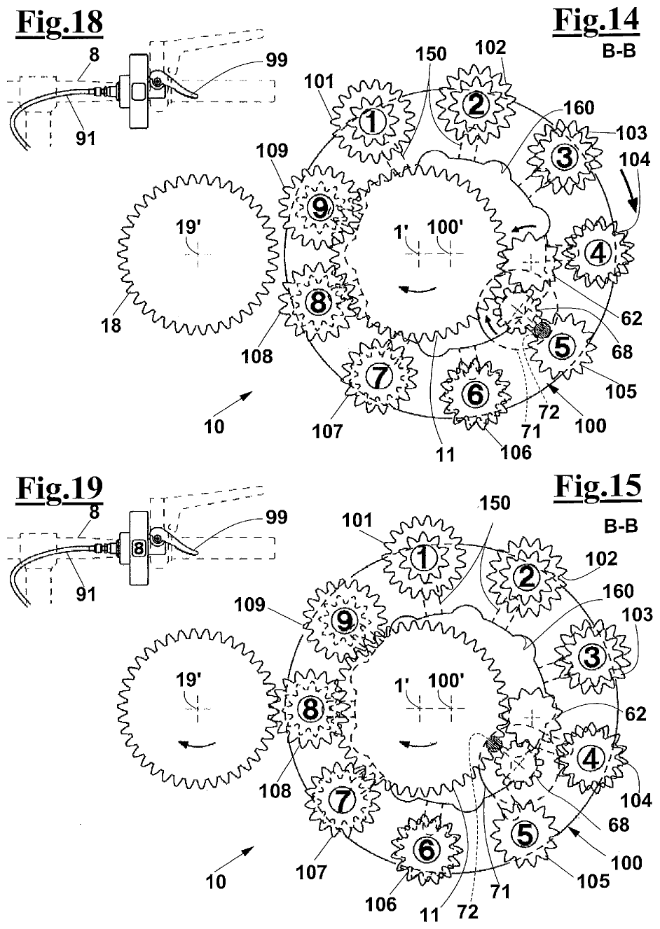

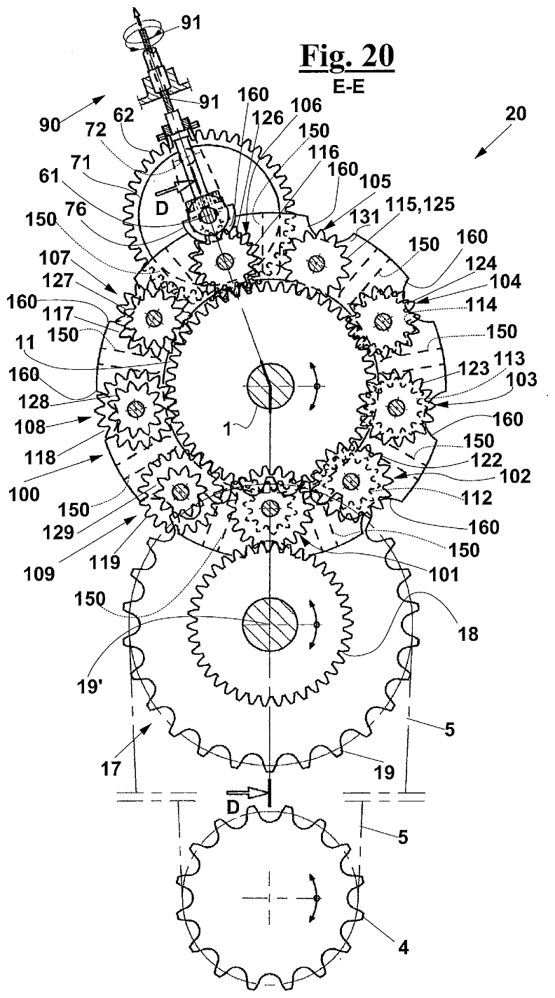

The sequence of FIGS. 12 to 15 shows the rotation of the rotary unit 100 in order to switch gears, i.e. to pass from gear ratio “9” to the adjacent gear ratio “8”. As the coupling toothed gear 62 stops with the coupling/decoupling tooth 64 in correspondence of the central wheel 11, as shown in FIG. 11, in order to actuate the transmission it is sufficient to rotate and immediately to release the lever 99, as shown in FIG. 16. As shown in FIG. 17, once the lever 99 has been released, it returns to the initial position due to the action of the cable 91, that is returned by the spring 97 (FIG. 11), and remains in this position during and after the step of gear ratio switching (FIGS. 18 and 19).

However, if the action on the lever 99 continues beyond the duration of one turn of the coupling gear 62, this latter continues to rotate getting through one or more intermediate gear ratios, and making a selectable gear pair 101-108 mesh with the central wheel 11 immediately after the release of the lever 99 corresponding to a gear ratio which is not adjacent to the initial one.

In the gear ratio switching step, the rotary unit 100 is driven into rotation by the central shaft 1 through the central wheel 11, the coupling gear 62, the auxiliary wheel 68 and the switching wheel 71, due to the effect of pedaling. If pedaling is such that the central shaft 1 rotates clockwise, as shown in FIGS. 12-15, the gear ratio is changed according to a sequence 9-8-7-6-5-4-3-2-1-9, whilst if pedaling is such that the central shaft 1 rotates counterclockwise the gear ratio changes according to a sequence 9-1-2-3-4-5-6-7-8-9. The clockwise and counterclockwise rotations of the central shaft 11 can correspond to a pedaling in the direction of actuation of the vehicle 9 and in the opposite direction, or vice versa, respectively. It is therefore possible to change, i.e. increase or decrease, the gear ratio, by respectively pedaling according to the actuation direction of the vehicle 9 or in opposite direction, or vice versa, and it is also possible to directly switch from the highest gear ratio to the lowest one and vice versa.

The device 10 preferably comprises blocking means 76,160 for preventing the rotary unit 100 from rotating with respect to the support 40 during the normal running of the vehicle 9, and anyway outside the gear ratio switching steps. In the embodiment of FIGS. 7 and 9, the blocking means comprise at least one blocking element 76 keyed to the secondary switching shaft 65, and a plurality of blocking seats 160 provided in areas of the rotary unit 100 that can be accessed by the blocking elements 76.

In particular, for the embodiment described above, FIG. 7 shows peripheral blocking recesses 160 provided along an edge, in this case the inner edge, of at least one of the rings 131,132 of the rotary unit 100. The blocking recesses 160 are uniformly angularly spaced around the axis of the rotary unit 100, always by said angle 2π/n.

The blocking means preferably comprise two blocking elements 76 keyed at a reciprocal distance equal to the distance between the rings 131,132, and the peripheral recesses 160 are provided along the edge, in this case the inner edge, of both the rings 131,132, preferably as pairs of longitudinally aligned recesses.

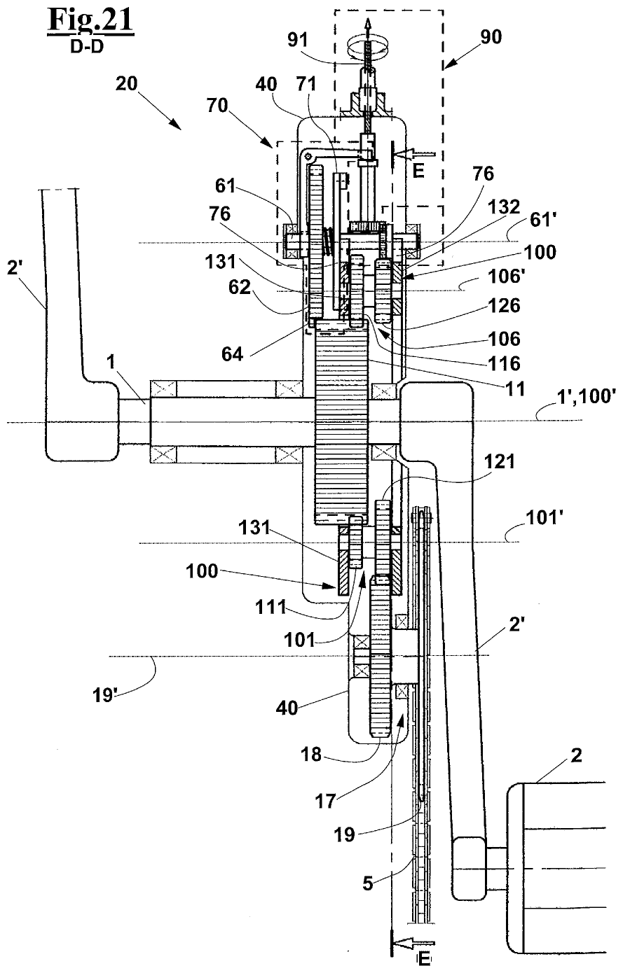

This arrangement of the blocking recesses 160 and of the control grooves 150 is also shown in FIG. 29, which refers to a third embodiment of the device according to the invention, while, in FIG. 20, with reference to a second embodiment, the control grooves 150 and the blocking recesses 160 are respectively opened on the outer edge of the ring 131 and of the ring 132.

In particular, the blocking element may comprise a half wheel 76 arranged so that the profile thereof is concentric with the switching wheel 71 and that, during the gear ratio switching step, the blocking element(s) 76 disengage the blocking recesses 160 corresponding to a current selectable gear pair immediately before, or exactly when, the switching pin 72 engages/disengages the radial control groove 150, so as to enable the rotation of the rotary unit 100 with respect to the casing 40.

To this end, in an embodiment of the invention the blocking element(s) 76 of each gear can be arranged in a position diametrically opposite to the switching pin 72.

FIG. 8 shows a detail of the device according to a variant of the first embodiment, wherein a toothed belt 5 is provided as transmission member and wherein the output and drive elements 4, 19 are toothed pulleys.

The device 10 is preferably provided with communication means for indicating the currently selected gear ratio to the rider of the vehicle 9. In the embodiment illustrated in FIG. 11, the communication means comprise a display device 200 arranged preferably on the handlebar 8, as shown in FIGS. 35-37, and are integrated in the switching unit 70 and in the actuator unit 90.

In more detail, the communication means employ a degree of torsional freedom of the cable 91 not used for actuating the switching unit 70. To this end, in addition to the auxiliary gear 68 and the switching gear 71 also a primary communication wheel 86 is keyed to the secondary switching shaft 65, while a secondary communication wheel 87 is integrally provided on a portion of the actuator 90 torsionally integral with the cursor 94 and with the cable 91. In particular, the secondary communication wheel 87 is provided peripherally with respect to the bush 95 where the cursor 94 can slide but cannot rotate. In this way, while the switching unit 70 rotates, i.e. during a step of gear ratio switching, also the primary communication wheel 86 makes a complete turn, and makes the secondary communication wheel 87 rotate by a given angle, causing an equal rotation of the cursor 94 and a rotation/torsion of the cable 91 (FIG. 11).

At the display device 200, the end of the cable 91 is inserted and blocked inside a cable gland gear 92 that therefore rotates integrally with the cable 91 during the gear ratio switching step (FIG. 35). The cable gland 92 is arranged so as to move an indicator 89 by means of the respective toothing. In this exemplary embodiment the indicator is an indicator ring 89 that is angularly displaced proportionally to the rotation of the primary and secondary communication wheels 86 and 87. In particular, the angular displacement of the indicator ring 89 is equal to the angle 2π/n for every complete turn of the primary communication wheel 86. On the periphery of the indicator ring 89 there is a number of symbols 88, indicating the gear ratio, equal to the number of selectable gear pairs equidistant from one another; the indicator ring is also arranged so that only one of the symbols 88, indicating the current or selected gear ratio, can be seen by the user through a window 21 of the display device 200 (FIG. 36). Therefore, every time a gear ratio switching step is performed, the symbol displayed in the display device 200 changes, passing from the symbol 88 indicating the previously selected gear ratio to the symbol 88 indicated the newly selected gear ratio.

### Second Embodiment

Referring to FIG. 20-22, a transmission device 20 according to a second embodiment of the invention is described hereafter. Similarly to the device of FIGS. 5-11, the output wheel 18 is external with respect to the rotary unit 100 and can directly mesh, in a selective way, with each selectable gear pair 101-109. The device 20 differs from the device 10 substantially in that the rotary unit 100 is mounted concentric with the central wheel 11, and in that all the selectable gear pairs 101-109 mesh at the same time with the central wheel 11, so that, while the vehicle 9 is running, all the gear pairs are rotating. Apart from that, during the normal running of the vehicle 9 the motion is transmitted as described with reference to the device 10.

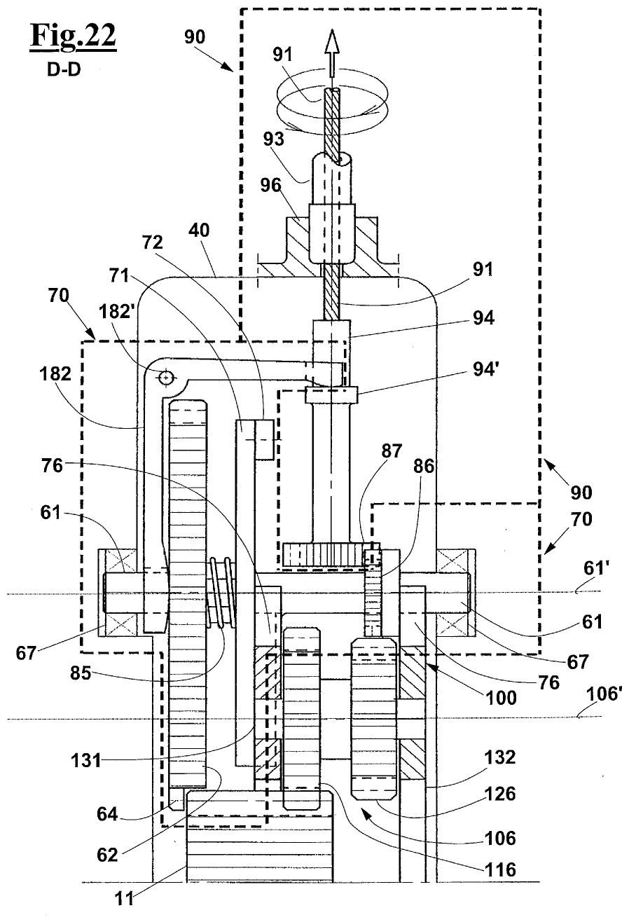

As shown in FIGS. 21 and 22, the switching unit 70 differs from the corresponding switching unit of the device 10 in that it comprises only one switching shaft 61 to which both the switching wheel 71, provided with the switching pin 72, and the coupling wheel 62, provided with the coupling/decoupling tooth 64, are keyed. An auxiliary wheel 68 for inverting the motion is therefore not provided (FIG. 11).

The manual actuator unit 90 of the device 20 comprises the same components of the corresponding actuator unit of the device 10 (FIG. 11), starting from the cable 91 up to the cursor 94. The manual actuator unit 90 further comprises a lever 182, which is rotatable around a pivot 182′ and has an arm abutting against a side protuberance, in particular an enlarged section 94′ of the cursor 94, and an opposite arm resting on the coupling wheel 62 that is mounted slidable along the switching shaft 61 but torsionally constrained to the switching shaft 61. In this way, a traction of the cable 91 causes a counterclockwise rotation of the lever 182 and therefore a translation of the coupling wheel 62 along the axis 61′, in direction of the switching wheel 71 and to such an extent that the coupling/decoupling tooth 64 meshes with the central wheel 11, making the switching shaft 61 rotating by one turn around the axis 61′, or more turns in case the traction of the cable 91 is prolonged, as already described above with reference to the device 10. This results in a rotation of the rotary unit 100 and changes the selectable gear pair 101-109 which engages the output wheel 18, thus switching the gear ratio. Elastic return means 85 are arranged between the axially fixed switching wheel 71 and the coupling wheel 62. The elastic return means 85 can comprise a compression spring 85, arranged in particular around the switching shaft 61, to return the coupling wheel 62 to the rest position when there is no more traction of the cable 91 of the manual actuator unit 90.

Referring again to FIG. 22, the actuator unit 90 and the switching unit 70 are in this case again configured to communicate the currently used gear ratio to the rider of the vehicle 9. To this end, the first and the second communication wheels 86, 87 are respectively keyed to the switching shaft 61 and to the cursor 94 and are arranged so that, when the switching shaft 61 and the first communication wheel 86 make a turn, the second communication wheel 87 and the cursor 94 rotate by a given angle, changing the displayed symbol indicating the gear ratio in the display device 200, as already described with reference to the device 10.

FIGS. 23, 24 and 43 show a device 20 according to a variant of the second embodiment, wherein a servo-assisted actuator unit 190 is provided instead of the manual actuator 90 of FIGS. 20 to 22. The servo-assisted actuator unit 190 comprises an actuation motor 191 provided with power supply means 192 and having an output rotatable shaft 193, to which a primary actuation gear 186 is keyed. A secondary actuation gear 187, meshing with the primary actuation gear 186, is keyed to the switching shaft 61 of the switching unit 70, arranged orthogonally to the output shaft 193.

The electric actuation motor 191 is configured so as to make the output shaft 193 rotate by angles equal to angle 2πz₂/z₁ (where z1 is the number of teeth of the primary actuation gear 186, and z₂ is the number of teeth of the secondary actuation gear 187), or to an integer multiple thereof, so as to cause, through the first and the second actuation wheels 186, 187 corresponding complete rotations and revolutions of respectively the switching wheel 71 and the switching pin 72 around the axis 61′, so as to make the rotary unit 100 rotate around the axis 100′ coinciding with the axis of the central shaft 1′, by an angle corresponding to the angular distance between a selectable gear pair 101 currently meshing with the output wheel 18 and another selectable gear pair from 102 to 109 corresponding to a desired gear ratio, in particular a selectable gear pair 102 or 109 that is adjacent to the currently selected selectable gear pair 101, thus switching to the new gear ratio, according to what described above with reference to the first variant of the device 20 (FIGS. 20-22) and to the device 10 (FIGS. 7-11).

In this case it is not necessary to provide mechanical means for indicating the current gear ratio, as the servo-assisted actuator unit 190 may be provided with a rotation counter, for example an encoder, not shown, and with program means configured to receive a signal from the rotation counter and to transfer to a display device 200 the new selected gear ratio, after every actuation of the actuator unit 190.

Similarly, a variant of the device 10 according to the first embodiment (FIGS. 7-11) may be provided, schematically shown in FIG. 39, provided with such servo-assisted actuator unit 190.

FIGS. 25, 26 and 44 show a device 20 according to a further variant of the second embodiment. The device 20 comprises an auxiliary motor 300 suitable to rotate the central shaft 1 and to provide an assisted pedaling. In some embodiments, as illustrated in the drawing, the auxiliary motor 300 may be an electric motor comprising a stator 31 provided with coils 32 connected to a power supply cable 33 and integral with the frame 3. The stator 31 is preferably fastened to the support or casing 40, and forms therewith an integrated device.

The motor 300 further comprises a rotor 36, in this case provided with permanent magnets 37, integral with the central wheel 11. The set formed by the central wheel 11 and the rotor 36 is connected to the central shaft 1 through a freewheel 39 and a bearing 38. The freewheel 39 is configured to transmit the rotary motion from the central shaft 1 to the central wheel 11 and therefore to the motor in only one rotation direction, in this case in the rotation direction resulting in the forward movement of the vehicle 9, only if the motion coming from the auxiliary electric motor 300 does not exceed, in torque and rotation speed, the motion imparted by the user coming from the central shaft 1. In other words the auxiliary motor 300 adds its drive action to that of the user until the motion coming from the central shaft 1 has a speed lower than the maximum speed of the motion coming from the auxiliary motor 300. Only if the rider pedals very slowly (or does not pedal, in case the local laws allows the motor operation also in this case), the auxiliary motor 300 makes the whole traction work of the vehicle. In this way the torque from the motor does not interfere with the free rotation of the central shaft 1, but acts only as an aid for said free rotation.

FIG. 34 shows an electric diagram for power supply of a transmission device 7, for instance according to the first or the second embodiment, comprising the auxiliary motor 300. The auxiliary motor 300 is electrically powered by a control unit 50 through the power cable 33. The control unit 50 is in turn powered by a battery 51 arranged on board of the vehicle 9. The control unit 50, as known for the pedal assist vehicles marketed in Countries where the law so requires, may be configured to power the auxiliary electric motor 300 only if the rider is pedaling; otherwise, the power supply is interrupted.

The freewheel 39 does not allow the rotation of the central wheel 11 in the direction opposite to the running direction of the vehicle 9, acting through the central shaft 1. To avoid the freewheel 39 preventing the device according to the invention from switching the gear ratio by reverse pedaling, i.e. by pedaling in a direction opposite to the running direction, a detector 57 may be provided for detecting the rotation direction of the central shaft 1, configured to generate a signal indicating the running direction. The control unit 50 is configured to receive the rotation direction signal through conventional electric connection means, for example through the power supply cable 33 of the motor 300. The control unit 50 is configured so as to enable, once detected the rotation direction signal, the rotation of the auxiliary motor 300 also in case of pedaling, and therefore of rotation of the central shaft 1, according to a direction opposite to the vehicle actuation direction, thus making the gear ratio switching always possible.

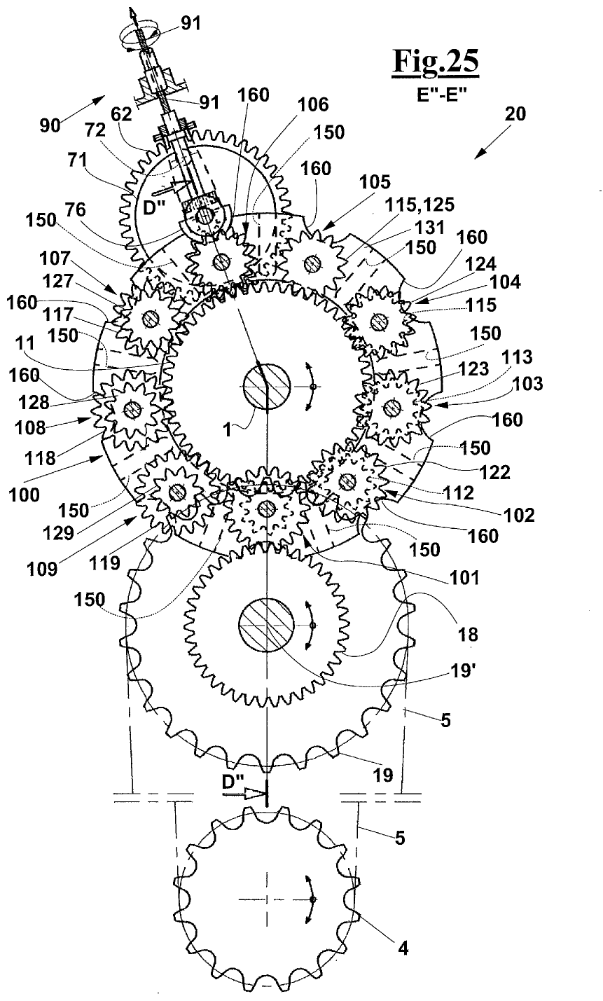

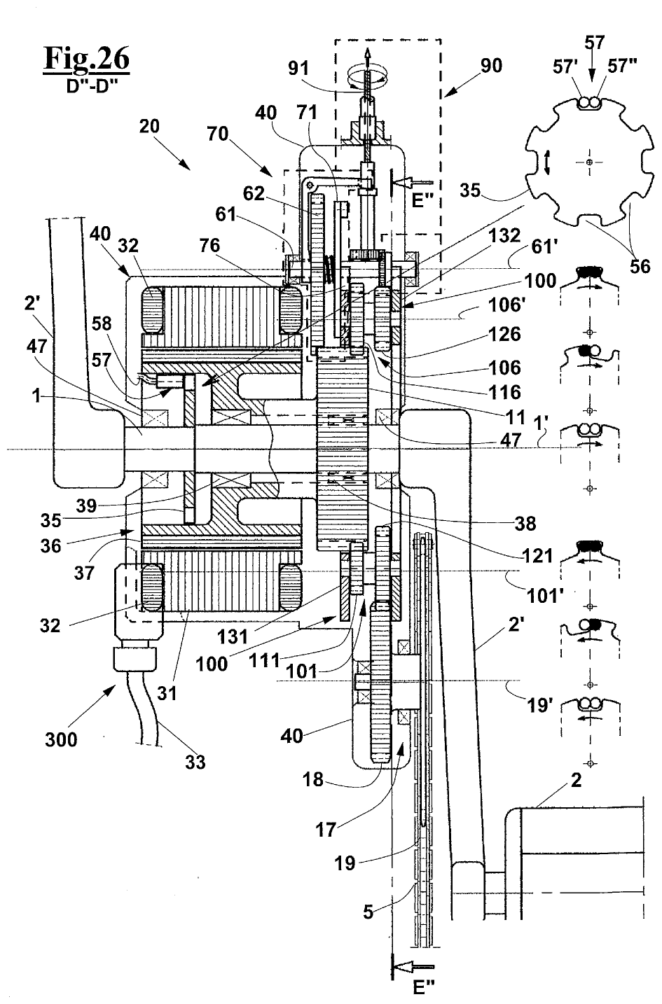

In an embodiment of the invention, the detector 57 for detecting the rotation direction comprises a disc 35 integrally keyed to the central shaft 1 and provided with peripheral windows or notches 56 that are angularly equidistant from each other, a pair of sensors 57′ and 57″ emitting a signal and integral with the support 40, a sensitive end of which is arranged close to the face of the disc 35, and that are adjacent to one another along to the circumferential direction of the disc 35, configured to emit signal “zero” or signal “one” and to change state when the windows 56 pass in front of them during the rotation of the disc 35. In this way, if the sensor 57′ is the first to change state, as shown in the sequence of FIG. 26, the control unit recognizes the clockwise rotation, and vice versa, and therefore the rotation direction is detected logically according to the sequence of state change of the sensors 57′ and 57″. Briefly, when the rider pedals forwards, the gear ratio switching may be performed due to the effect of human force or the force of the electric motor, while when the user pedals in opposite direction, the gear ratio switching may be performed due to the effect of the force of the electric motor, even if the vehicle is still.

Apart from what illustrated above, the motion transmission during the normal running, as well as the gear ratio switching steps are performed according to what described above with reference to the first variant of the device 10.

With reference to FIG. 34 again, on the handlebar 8, or in a position accessible by the user, the controls 59′ and 59″ of the auxiliary electric motor 300 are arranged, connected to the control unit 50 preferably through electrical connection means 34.

Alternatively or in combination, the device 7 of respectively FIGS. 33 and 34 is provided with a servo-assisted actuator unit 190, as described with reference to FIG. 24, and it is actuated through the control unit 50. The controls 198 and 199 of the actuator unit 190 are also shown, arranged preferably near the display device 200 indicating the current gear ratio.

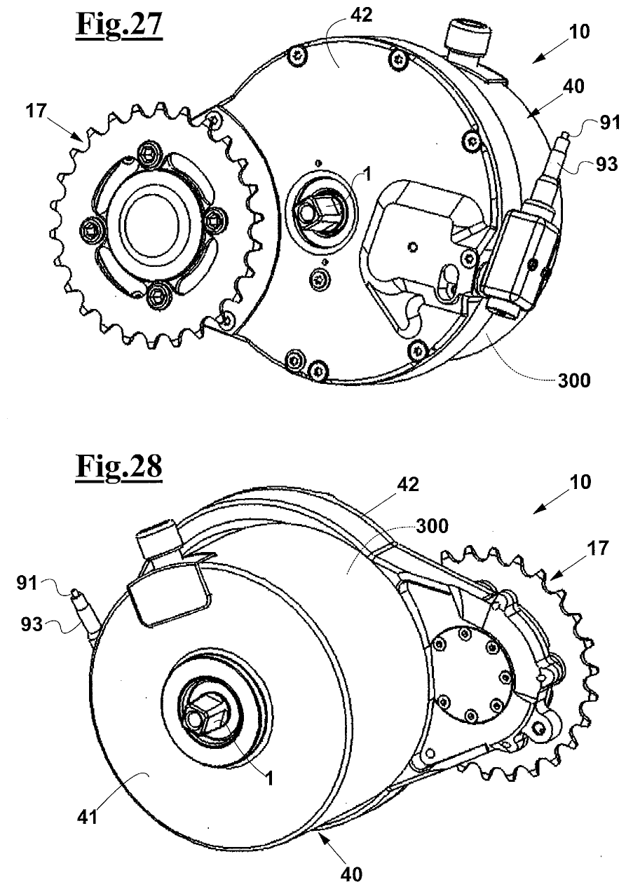

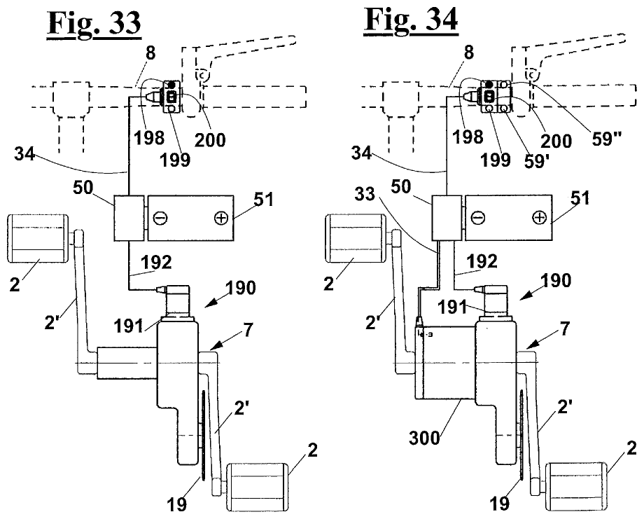

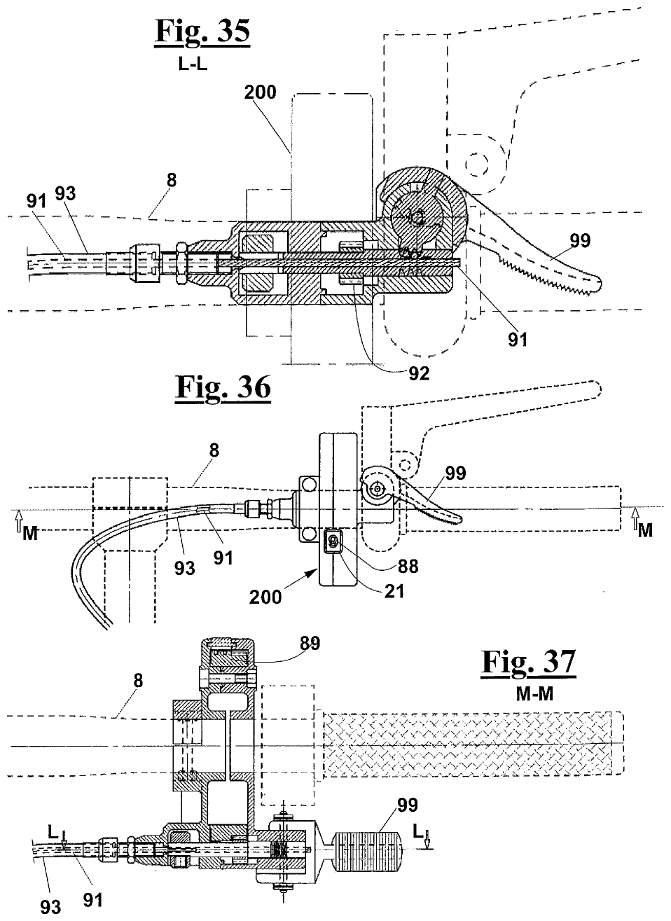

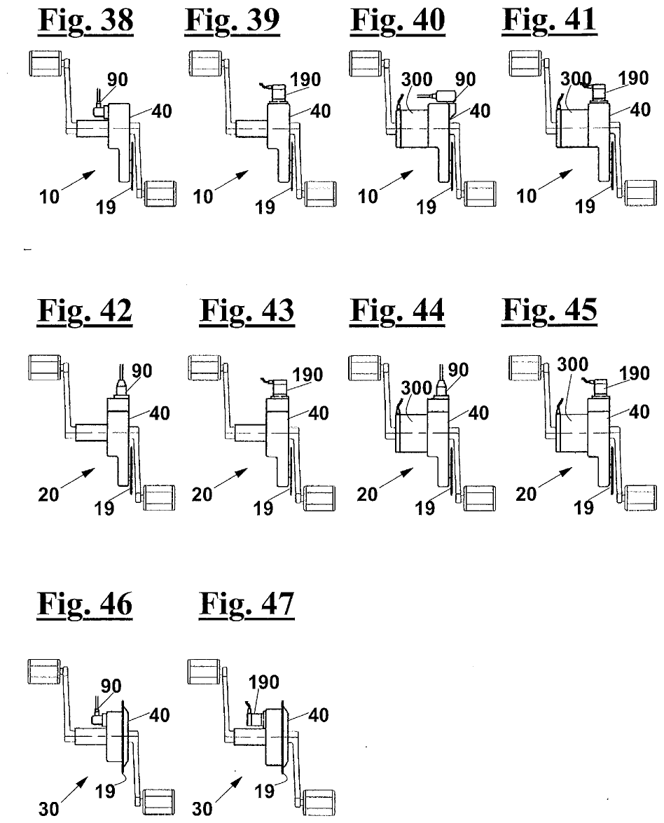

Similarly, as shown in FIGS. 27 and 28, a variant of the device 10 according to the first embodiment (FIGS. 7-11) may be provided, schematically shown in FIG. 40 and comprising an auxiliary electric motor 300 as described above and the related actuations.

In a further embodiment, as schematically shown in FIG. 45, the device 20 comprises a servo-assisted actuator unit 190 and an auxiliary electric motor 300. Similarly, a variant of the device 10 according to the first embodiment (FIGS. 7-11) may be provided, schematically shown in FIG. 41 and comprising both a servo-assisted actuator unit 190 and an auxiliary electric motor 300 and the related actuations.

### Third Embodiment

Referring to FIGS. 29-32, a transmission device 30 is described according to a third embodiment of the invention. The device 30 differs from the device 10 and from the device 20 substantially in that the output wheel 18 is concentric to the rotary unit 100, and is provided as an inner gear of the sprocket 19, and in that the central wheel 11 engages the selectable gear pairs 101-109 through an intermediate rotatable gear or shaft 13, arranged rotatable around the axis 13′. More precisely, the intermediate gear 13 comprises a first intermediate wheel 14 meshing with the central wheel 11 and a second intermediate wheel 15 parallel to the first intermediate wheel 14 that can selectively mesh with each selectable gear pair from 101 to 109. Therefore, the rotary motion of the central wheel 11 is transmitted to the engaged selectable gear pair 101-109 through the first and the second intermediate wheel 14, 15 of the intermediate gear 13. Apart from that, during the normal running of the vehicle 9 the motion is transmitted according to what described above with reference to the devices 10 (FIGS. 7-11) and 20 (FIGS. 20-22).

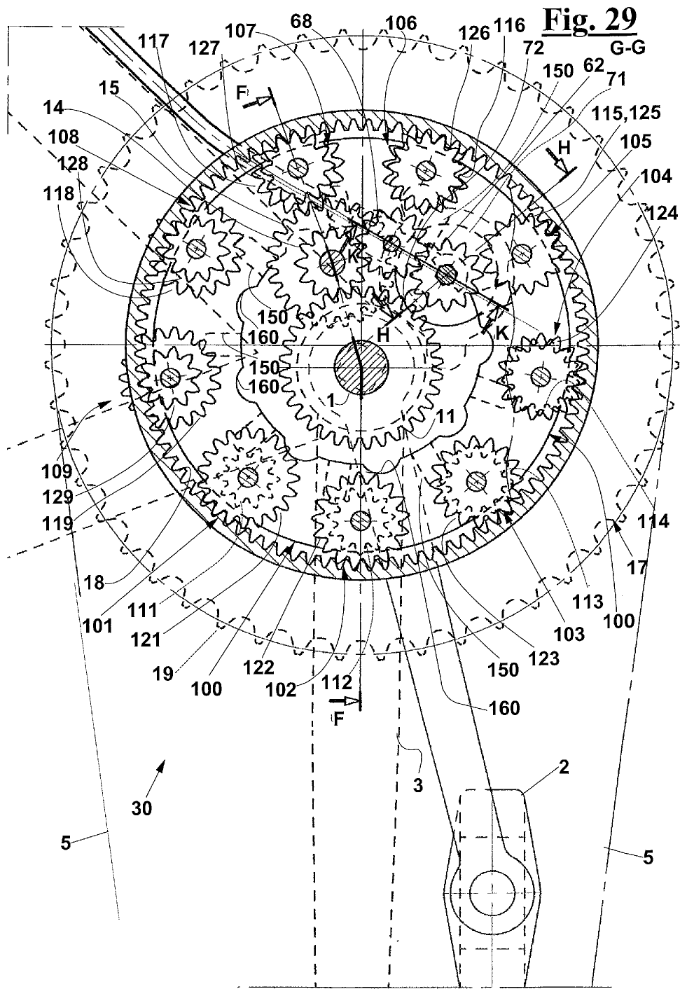

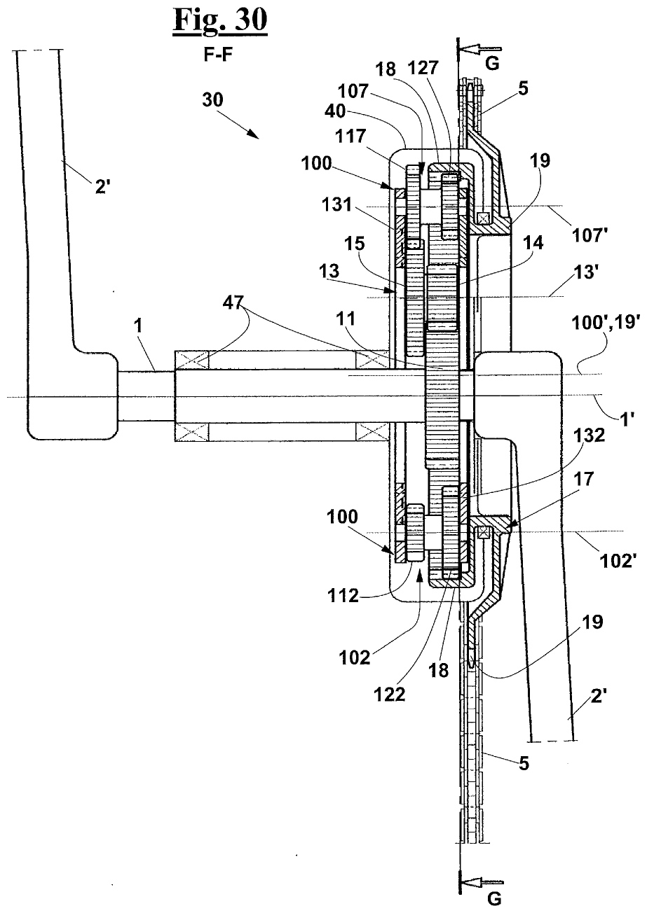

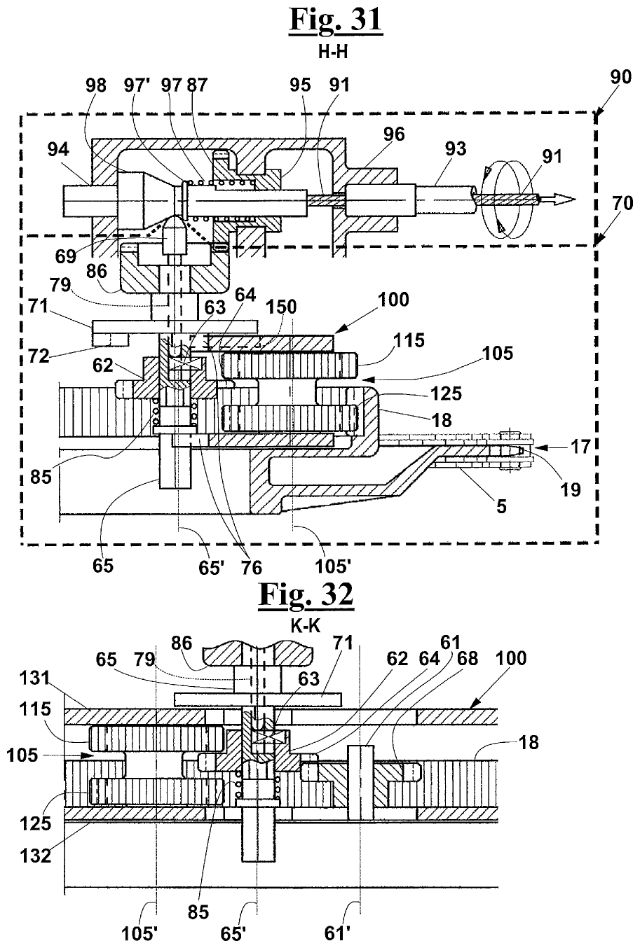

As shown in FIGS. 31 and 32, the switching unit 70 differs from the corresponding switching unit of the device 10, and is similar to that of the device 20, in that both the switching wheel 71, provided with the switching pin 72, and the coupling wheel 62, provided with the incomplete coupling/decoupling tooth 64, are keyed to a same switching shaft, in this case the secondary switching shaft 65 rotatable around the rotation axis 65′. Analogously to the device 10, a further switching shaft 61 is provided, in this case the primary switching shaft 61, on which the auxiliary or inversion wheel 68 is rotatable arranged, meshing with the coupling toothed gear 62 through the coupling/decoupling tooth 64. However, the auxiliary or inversion wheel 68, and therefore the whole switching unit 70, receives the rotary motion from the first intermediate wheel 14 that always meshes with the auxiliary wheel 68 and that, like this latter, moves continuously during the normal running of the vehicle 9.

Moreover, the manual actuator 90 comprises the same components as the corresponding actuator unit 90 of the device 10 (FIG. 11). In more detail, as shown in FIG. 31, a traction of the cable 91 of the manual actuator unit 90 causes a translation of the pin 79 arranged slidable inside the secondary switching shaft 65, pushing the projecting tab 63 and making the coupling wheel engage the auxiliary wheel 68, always moving, through the coupling/decoupling tooth 64. In this way the secondary switching shaft 65 is driven into rotation and the switching wheel 71 and the switching pin 72 make respectively a complete rotation and a complete revolution around the axis 65′, causing the rotation of the rotary unit 100 and the switching of the gear, analogously to what described above with reference to the devices 10 and 20.

With reference again to FIG. 31, also in this case the actuator unit 90 and the switching unit 70 are configured to communicate the currently used gear ratio to the user through the first and the second communication wheels 86, 87 that are respectively keyed to the secondary switching shaft 65 and to the cursor 94, similarly to what described above with reference to the device 10.

Moreover, as schematically shown in FIG. 47, a variant, not shown, of the device 30 according to the third embodiment may be provided, comprising a servo-assisted actuator unit 190 as described above with reference to the device 20 of the second embodiment.

As shown in FIG. 4, the device 30 preferably comprises an elastic tensioning device 80 for tensioning the chain. This is needed, in particular, if the connection of the pinion 4 to the frame 3 does not allow modifying the position of the wheel according to the longitudinal direction of the vehicle, by adjusting the chain tension. In particular, this condition of fixed axis can be seen in case of bicycles for rough roads, such as mountain bikes. The elastic tensioning device 80 may be also provided in the devices 10 and 20 according to the other embodiments of the invention.

The above description of specific embodiments discloses the invention from a conceptual viewpoint, so that other people, using the known technique, can modify and/or adapt in various applications these specific embodiments without further researches and without departing from the concept of the invention, and therefore it is intended that such adaptations and modifications shall be considered as equivalent to the specific embodiments. Means and materials to embody the various described functions can be of various nature without however departing from the protective scope of the present invention. It should be understood that used expressions and terminology have only descriptive, and therefore non limiting, purpose.

1. A transmission comprising:
a support for rotatably supporting an input central shaft;
a central wheel integral with the central shaft and rotating therewith;
an output wheel;
a rotary unit rotatably supported by the support around a rotation axis to take a plurality of angular positions;
a plurality of selectable gear pairs each of which gear pairs is rotatably mounted on the rotary unit;
a rotation mechanism of the rotary unit adapted to bring selectively the rotary unit into one of said angular positions;
wherein in each angular position of the rotary unit a respective one of said selectable gear pairs transmits motion from the central wheel to the output wheel;
and wherein each selectable gear pair is configured to provide a different gear ratio between the central wheel and the output wheel.

2. The transmission according to claim 1, wherein each selectable gear pair comprises a respective primary gear and a respective secondary gear.

3. The transmission according to claim 2, wherein a ratio between a diameter of the primary gear and a diameter of the respective secondary gear differs between the selectable gear pairs, so as to define a different gear ratio of the transmission for each selectable gear pair.

4. The transmission according to claim 2, wherein the rotary unit comprises two parallel rings mounted perpendicularly to the central shaft, and wherein the selectable gear pairs are arranged between the two rings, with the respective rotation axes thereof perpendicular to the two rings.

5. The transmission according to claim 4, wherein the primary gear and the secondary gear of each selectable gear pair are parallel to each other, integral with an intermediate hub portion and spaced from one another by said intermediate hub portion, so as to be respectively adjacent to the rings of the rotary unit.

6. The transmission according to claim 1, wherein the central wheel engages said selectable gear pairs through an intermediate gear comprising a first intermediate wheel meshing with the central wheel and a second intermediate wheel selectively meshing with each selectable gear pair according to the angular position taken by the rotary unit through the rotation mechanism.

7. The transmission according to claim 6, wherein the output wheel is concentric with the rotary unit and has a toothing meshing with the selectable gear pairs; wherein the output wheel is configured as an inner gear; and wherein all the selectable gear pairs mesh simultaneously with the output wheel.

8. The transmission according to claim 1, wherein the output wheel is external with respect to the rotary unit and selectively meshes with only one of said selectable gear pairs and wherein the rotary unit is eccentric with respect to the central wheel so that the selectable gear pairs selectively mesh, one at a time, with the central wheel.

9. The transmission according to claim 1, wherein the output wheel is external with respect to the rotary unit and selectively meshes with only one of said selectable gear pairs and wherein the rotary unit is concentric with respect to the central wheel so that all said selectable gear pairs simultaneously mesh with the central wheel.

10. The transmission according to claim 1, wherein the rotation mechanism comprises a switching unit configured to selectively perform a switching movement and to make the rotary unit displace angularly around the rotation axis thereof so as: to disengage a currently selected gear pair from a mechanical transmission between the central wheel and the output wheel; and to make a further selectable gear pair, different from said current selected gear pair, engage the mechanical transmission between the central wheel and the output wheel.

11. The transmission according to claim 10, further comprising an actuator unit to control the switching movement of the switching unit, wherein the actuator unit is selected among: a manual actuator unit provided with an actuation control; and a servo-assisted actuator unit provided with an actuation motor having control buttons.

12. The transmission according to claim 11, wherein: the switching unit comprises a switching wheel provided with a drawing member suitable to couple to the rotary unit; the rotary unit is provided with a plurality of radial grooves arranged around the rotation axis of the rotary unit uniformly angularly spaced and suitable to couple to the drawing member of the switching wheel; so that a rotation of the switching wheel makes the drawing member engage a radial groove and, as the rotation continues, the drawing member makes the rotary unit rotate by an angle equal to an angle of 360° divided by the number of selectable gear pairs.

13. The transmission according to claim 12, wherein the switching unit comprises a coupling toothed gear with a longitudinally incomplete coupling/decoupling tooth, and the actuator unit is configured to cause a translation of the coupling toothed wheel from a position of normal running to a switching position, such that:
in the switching position the coupling/decoupling tooth meshes with said central wheel or with an auxiliary wheel rotatably actuated by the central wheel, so that the central wheel, when rotating, draws the coupling toothed gear into rotation; and that
the coupling/decoupling tooth disengages from the central wheel or the auxiliary wheel when the rotary unit has rotated by a desired angle around the axis thereof, stopping said coupling toothed gear.

14. The transmission according to claim 13, wherein the coupling toothed gear and the switching wheel are connected to one another such that the rotation and the stopping of the coupling wheel results in the rotation and the stopping of the switching wheel.

15. The transmission according to claim 12, further comprising elastic return means for returning to a normal running position, the elastic return means being associated with the coupling toothed gear such that, upon actuating the actuator unit without retention thereof, the coupling toothed gear and the switching wheel make only one turn up to a position of disengagement of the longitudinally incomplete tooth, and therefore the rotary unit rotates causing the switching from a gear ratio to a contiguous gear ratio.

16. The transmission according to claim 10, wherein the switching unit comprises at least one angular blocking element for blocking the rotary unit, and the rotary unit is provided with a plurality of recesses that are uniformly angularly spaced around the rotation axis of the rotary unit and are configured selectively to engage the blocking element; the blocking element being arranged to disengage the peripheral recesses when the switching unit causes the rotation of the rotary unit.

17. The transmission according to claim 16, wherein the blocking element is integral with the switching wheel and is in a given angular position with respect to the drawing member, and wherein the peripheral recesses are angularly offset with respect to the radial grooves by such an offset angle that, when the drawing member engages one of the radial grooves, during said rotation of the switching wheel, the angular blocking element disengages one of the recesses.

18. The transmission according to claim 17, wherein the recesses are provided in correspondence of an edge of at least one of said two rings, and the recesses are formed in pairs in correspondence of edges of each of said two rings, in corresponding angular positions.

19. The transmission according to claim 10, wherein the manual actuator unit comprises a cable, constrained at one end to said actuation control so as to receive a traction therefrom and, at a second end, to an actuation element configured to cause said switching movement of said switching unit due to said traction.

20. The transmission according to claim 19, wherein the second end of the cable is torsionally constrained to the switching unit so that, when the switching unit angularly displaces the rotary unit, the cable makes a rotation depending on the angular displacement.

21. The transmission according to claim 20, further comprising a display device wherein an indicator is provided, configured to move depending on said rotation of the cable, so as to display a symbol indicating the current gear ratio.

22. The transmission according to claim 1, further comprising an auxiliary motor associated with the central wheel, so as to transmit a rotary motion to the central wheel, that can be added to the motion imparted through the central shaft.

23. The transmission according to claim 22, further comprising: a detector for detecting a presence of the central shaft and detecting a rotation direction of the central shaft, the detector being adapted to emit a signal according to the rotation direction of the central shaft; a control unit adapted to: receiving and recognizing said rotation direction signal, and enabling a rotation of the auxiliary motor in the same direction as the rotation direction of the central shaft; so as to allow the gear ratio switching made proceeding in the direction depending on the rotation direction of the central shaft.

24. A vehicle comprising:
a frame;
at least a drive wheel arranged rotatable on the frame and provided with a drive element;
a transmission comprising: a support which is rigidly fastened to the frame; an input central shaft rotatably supported in said support; a central wheel integral with the central shaft and rotating therewith; an output wheel; a rotary unit rotatably supported by the support around a rotation axis to take a plurality of angular positions; a plurality of selectable gear pairs each of which is rotatably mounted on the rotary unit; a rotation mechanism of the rotary unit adapted to bring selectively the rotary unit into one of said angular positions; wherein in each angular position of the rotary unit a respective one of said selectable gear pairs transmits motion from the central wheel to the output wheel; and wherein each selectable gear pair is configured to provide a different gear ratio between the central wheel and the output wheel;
members for transmitting torque to the central shaft; and
a mechanical transmission configured to transmit motion from the output wheel of the transmission to the drive of the drive wheel.

25. A vehicle according to claim 24, wherein the mechanical transmission comprises:
an output rotatable element, supported rotatable by said support of the transmission and mechanically coupled to the output wheel of the transmission; and
a member for transmitting motion from the output rotatable element to the drive of the drive wheel.

26. A vehicle according to claim 24, wherein the members for transmitting torque to the central shaft of the transmission comprise at least one member for actuation through the muscle force of the vehicle's user.
